(19) United States
(12) Patent Application Publication
(10) Pub. No.: US 2016/0103856 A1
(43) Pub. Date: Apr. 14, 2016

(54) INTEGRATING CUSTOMIZED USER EXPERIENCES

(71) Applicant: salesforce.com, inc., San Francisco, CA (US)

(72) Inventor: Charlie Isaacs, San Jose, CA (US)

(21) Appl. No.: 14/512,435

(22) Filed: Oct. 12, 2014

(51) Int. Cl. G06F 17/30; H04L 29/08

(52) U.S. Cl. CPC G06F 17/30289; G06F 17/3051; G06F 17/30345; H04L 67/306

(57) ABSTRACT

Disclosed are some examples of systems, apparatus, methods and storage media for generating and integrating experiences for a user to provide an amalgamated experience. In some implementations, a system includes an experience-generating platform configured to receive event data indicating the occurrence of an event; determine whether one or more triggers are satisfied based on the event data; when a one of the triggers is satisfied, identify a next one of the activities; and when a last one of the triggers is satisfied or a last one of the activities is determined to completed, determine that the experience has ended and identify a next activity associated with a next experience.

### COPYRIGHT NOTICE

A portion of the disclosure of this patent document contains material which is subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### TECHNICAL FIELD

This patent document relates generally to providing experiences to a customer, and more specifically, to a system for integrating experiences across organizations to provide an amalgamated experience to a customer.

### BACKGROUND

“Cloud computing” services provide shared resources, software, and information to computers and other devices upon request or on demand. Cloud computing typically involves the over-the-Internet provision of dynamically-scalable and often virtualized resources. Technological details can be abstracted from end-users, who no longer have need for expertise in, or control over, the technology infrastructure “in the cloud” that supports them. In cloud computing environments, software applications can be accessible over the Internet rather than installed locally on personal or in-house computer systems. Some of the applications or on-demand services provided to end-users can include the ability for a user to create, view, modify, store and share documents and other files.

### BRIEF DESCRIPTION OF THE DRAWINGS

The included drawings are for illustrative purposes and serve to provide examples of possible structures and operations for the disclosed inventive systems, apparatus, methods and computer-readable storage media. These drawings in no way limit any changes in form and detail that may be made by one skilled in the art without departing from the spirit and scope of the disclosed implementations.

FIG. 1A shows a block diagram of an example environment in which an on-demand database service can be used according to some implementations.

FIG. 1B shows a block diagram of example implementations of elements of FIG. 1A and example interconnections between these elements according to some implementations.

FIG. 2A shows a system diagram of example architectural components of an on-demand database service environment according to some implementations.

FIG. 2B shows a system diagram further illustrating example architectural components of an on-demand database service environment according to some implementations.

FIG. 3 shows an example of a group feed on a group profile page according to some implementations.

FIG. 4 shows an example of a record feed on a record profile page according to some implementations.

FIG. 5 shows an example of an experience-generating platform according to some implementations.

FIG. 6 shows an example of an interface provided by an experience-building application for enabling an organization to generate a customized experience for a customer according to some implementations.

FIG. 7 shows an example of an interface provided by an experience-building application for enabling an organization to generate a customized experience for a customer according to some implementations.

FIG. 8 shows an example of a more specific interface provided by an experience-building application for enabling an organization to define and associate trigger data for a custom experience according to some implementations.

FIG. 9 shows an example of an interface provided by the experience-building application for enabling a hotel organization to view, access or generate a customized experience for a customer according to some implementations.

FIG. 10 shows an example of an interface enabling an organization to generate an amalgamated experience for a customer by combining two or more customized experiences generated for the customer according to some implementations.

FIG. 11 shows an example of an interface enabling a customer to view or modify information associated with one or more customized experiences according to some implementations.

FIG. 12 shows an example of an interface enabling a customer to view or modify preferences associated with one or more customized experiences according to some implementations.

FIG. 13 shows an example of an interface enabling a customer to modify one or more activities associated with one or more customized experiences according to some implementations.

FIG. 14 shows a graphical representation of an example of a process flow for an airline flight experience according to some implementations and applications.

FIG. 15 shows a graphical representation of an example of a process flow for an airline landing experience according to some implementations and applications.

FIG. 16 shows a graphical representation of an example of a process flow for a shuttle experience according to some implementations and applications.

FIG. 17 shows a graphical representation of an example of a process flow for a car rental experience according to some implementations and applications.

FIG. 18 shows a graphical representation of an example of a process flow for a gate automation activity associated with a car rental experience according to some implementations and applications.

FIG. 19 shows a graphical representation of an example of a process flow for a gate automation activity associated with a car rental experience according to some implementations and applications. The experience/activity can also include using a beacon to determine the car's presence at the gate. The activity also can include generating an automatic damage image record (taking a picture of damage at the gate), using a picture to verify a license plate of the car, and scanning a driver's license: all to facilitate an automatic exit/gate control and damage record without requiring a car rental agency attendant.

FIG. 20 shows a graphical representation of an example of a process flow for a car rental navigation and support experience according to some implementations and applications.

FIG. 21 shows a graphical representation of an example of a process flow for a hotel experience according to some implementations and applications.

FIG. 22 shows a graphical representation of an example of an interface for use by a hotel in providing a customized experience to a customer of the hotel to some implementations and applications.

### DETAILED DESCRIPTION

Examples of systems, apparatus, computer-readable storage media, and methods according to the disclosed implementations are described in this section. These examples are being provided solely to add context and aid in the understanding of the disclosed implementations. It will thus be apparent to one skilled in the art that the disclosed implementations may be practiced without some or all of the specific details provided. In other instances, certain process or method operations, also referred to herein as “blocks,” have not been described in detail in order to avoid unnecessarily obscuring the disclosed implementations. Other implementations and applications also are possible, and as such, the following examples should not be taken as definitive or limiting either in scope or setting.

In the following detailed description, references are made to the accompanying drawings, which form a part of the description and in which are shown, by way of illustration, specific implementations. Although these disclosed implementations are described in sufficient detail to enable one skilled in the art to practice the implementations, it is to be understood that these examples are not limiting, such that other implementations may be used and changes may be made to the disclosed implementations without departing from their spirit and scope. For example, the blocks of the methods shown and described herein are not necessarily performed in the order indicated in some other implementations. Additionally, in some other implementations, the disclosed methods may include more or fewer blocks than are described. As another example, some blocks described herein as separate blocks may be combined in some other implementations. Conversely, what may be described herein as a single block may be implemented in multiple blocks in some other implementations. Additionally, the conjunction “or” is intended herein in the inclusive sense where appropriate unless otherwise indicated; for example, the phrase “A, B or C” is intended to include the possibilities of “A,” “B,” “C,” “A and B,” “B and C,” “A and C” and “A, B and C.”

Some implementations described and referenced herein are directed to systems, apparatus, computer-implemented methods and computer-readable storage media for generating and providing custom experiences to a user, such as a customer of one or more organizations. Some implementations described and referenced herein also are directed to systems, apparatus, computer-implemented methods and computer-readable storage media for integrating experiences across organizations to provide an amalgamated experience to a customer. In some implementations, an experience-generating platform enables an organization or partnership of organizations to provide or facilitate a customized 1:1 custom experience to a customer user across a number of various channels and devices. In some implementations, the experience-generating platform includes an experience-building application and an experience-mediating application.

In some implementations, the experience-generating platform is configured to amalgamate, combine, merge, link, chain, reconcile or otherwise integrate two or more experiences generated for the same customer to generate or determine an amalgamated experience for the customer. For example, the experience-generating platform can advantageously generate an amalgamated experience that seamlessly links two or more experiences, facilitates handoffs between two or more experiences or two or more respective organizations, and which maintains a customer's identify and tracks the customer's actions (as event data) throughout a journey or flow through the experiences. In some implementations, various organizations can form partnerships facilitating an amalgamated experience including experiences generated and provided by each of two or more of the organizations. For example, an airline can partner with a car rental agency and a hotel to facilitate an amalgamated experience associated with a business trip or vacation. Such organizations can share information with one another. The experience-generating platform can advantageously streamline the booking, planning, organizing, providing and handing off of various experiences, and the activities in the experiences, associated with such a trip from start to finish with minimal input from the customer and minimal interaction with representatives of the various organizations. For example, many of such activities can be automated and facilitated using a mobile device as described herein allowing a customer to bypass various lines and other experiences associated with physically interacting with human representatives or employees of the respective organizations during the trip. In some implementations, the experience-generating platform generates the amalgamated experience such that the customer is not required to provide additional input or to access the experiences or respective organizations individually.

In some implementations, the customers, employees or other users described herein are users (or “members”) of an interactive online “enterprise social network,” also referred to herein as a “social networking system,” an “enterprise social networking system,” an “enterprise collaborative network,” or more simply as an “enterprise network.” Such online enterprise networks are increasingly becoming a common way to facilitate communication among people, any of whom can be recognized as enterprise users. One example of an online enterprise social network is Chatter®, provided by salesforce.com, inc. of San Francisco, Calif. salesforce.com, inc. is a provider of enterprise social networking services, customer relationship management (CRM) services and other database management services, any of which can be accessed and used in conjunction with the techniques disclosed herein in some implementations. These various services can be provided in a cloud computing environment as described herein, for example, in the context of a multi-tenant database system. Some of the described techniques or processes can be implemented without having to install software locally, that is, on computing devices of users interacting with services available through the cloud. While the disclosed implementations may be described with reference to Chatter® and more generally to enterprise social networking, those of ordinary skill in the art should understand that the disclosed techniques are neither limited to Chatter® nor to any other services and systems provided by salesforce.com, inc. and can be implemented in the context of various other database systems such as cloud-based systems that are not part of a multi-tenant database system or which do not provide enterprise social networking services.

### I. Example System Overview

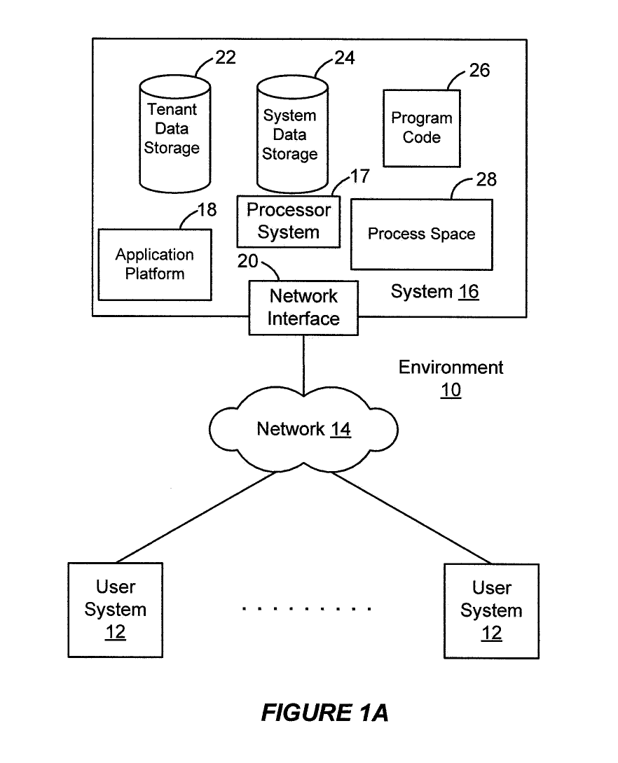

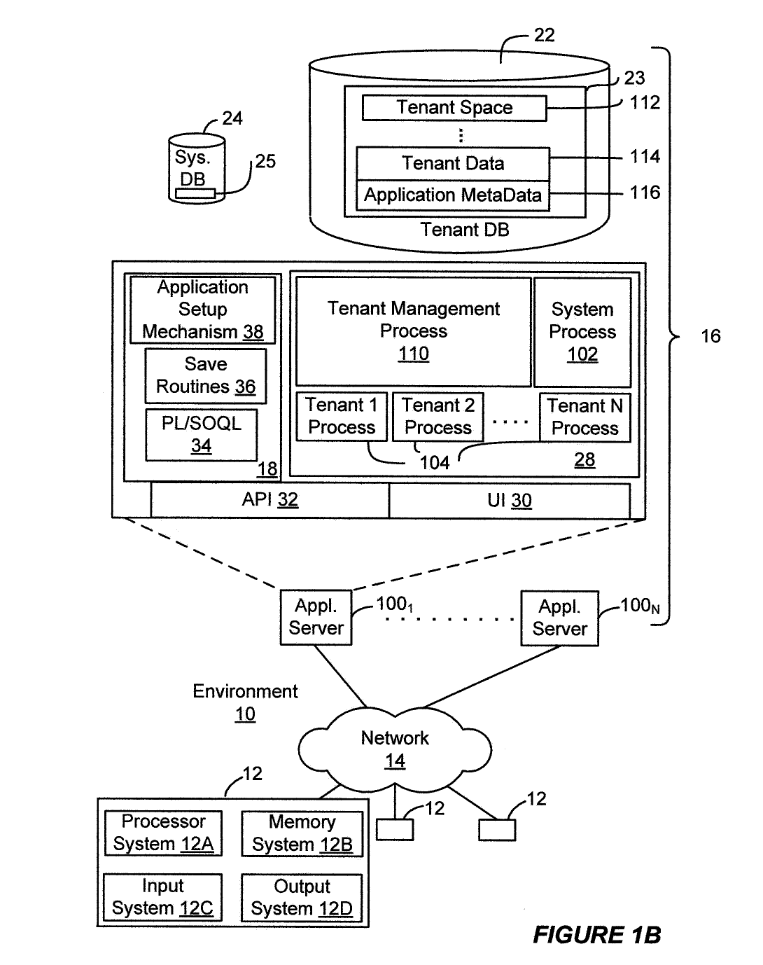

FIG. 1A shows a block diagram of an example of an environment 10 in which an on-demand database service can be used in accordance with some implementations. The environment 10 includes user systems 12, a network 14, a database system 16 (also referred to herein as a “cloud-based system”), a processor system 17, an application platform 18, a network interface 20, tenant database 22 for storing tenant data 23, system database 24 for storing system data 25, program code 26 for implementing various functions of the system 16, and process space 28 for executing database system processes and tenant-specific processes, such as running applications as part of an application hosting service. In some other implementations, environment 10 may not have all of these components or systems, or may have other components or systems instead of, or in addition to, those listed above.

In some implementations, the environment 10 is an environment in which an on-demand database service exists. An on-demand database service, such as that which can be implemented using the system 16, is a service that is made available to users outside of the enterprise(s) that own, maintain or provide access to the system 16. As described above, such users generally do not need to be concerned with building or maintaining the system 16. Instead, resources provided by the system 16 may be available for such users' use when the users need services provided by the system 16; that is, on the demand of the users. Some on-demand database services can store information from one or more tenants into tables of a common database image to form a multi-tenant database system (MTS). The term “multi-tenant database system” can refer to those systems in which various elements of hardware and software of a database system may be shared by one or more customers or tenants. For example, a given application server may simultaneously process requests for a great number of customers, and a given database table may store rows of data such as feed items for a potentially much greater number of customers. A database image can include one or more database objects. A relational database management system (RDBMS) or the equivalent can execute storage and retrieval of information against the database object(s).

Application platform 18 can be a framework that allows the applications of system 16 to execute, such as the hardware or software infrastructure of the system 16. In some implementations, the application platform 18 enables the creation, management and execution of one or more applications developed by the provider of the on-demand database service, users accessing the on-demand database service via user systems 12, or third party application developers accessing the on-demand database service via user systems 12.

In some implementations, the system 16 implements a web-based customer relationship management (CRM) system. For example, in some such implementations, the system 16 includes application servers configured to implement and execute CRM software applications as well as provide related data, code, forms, renderable web pages and documents and other information to and from user systems 12 and to store to, and retrieve from, a database system related data, objects, and Web page content. In some MTS implementations, data for multiple tenants may be stored in the same physical database object in tenant database 22. In some such implementations, tenant data is arranged in the storage medium(s) of tenant database 22 so that data of one tenant is kept logically separate from that of other tenants so that one tenant does not have access to another tenant's data, unless such data is expressly shared. The system 16 also implements applications other than, or in addition to, a CRM application. For example, the system 16 can provide tenant access to multiple hosted (standard and custom) applications, including a CRM application. User (or third party developer) applications, which may or may not include CRM, may be supported by the application platform 18. The application platform 18 manages the creation and storage of the applications into one or more database objects and the execution of the applications in one or more virtual machines in the process space of the system 16.

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (for example, in a server farm located in a single building or campus), or they may be distributed at locations remote from one another (for example, one or more servers located in city A and one or more servers located in city B). As used herein, each MTS could include one or more logically or physically connected servers distributed locally or across one or more geographic locations. Additionally, the term “server” is meant to refer to a computing device or system, including processing hardware and process space(s), an associated storage medium such as a memory device or database, and, in some instances, a database application (for example, OODBMS or RDBMS) as is well known in the art. It should also be understood that “server system” and “server” are often used interchangeably herein. Similarly, the database objects described herein can be implemented as part of a single database, a distributed database, a collection of distributed databases, a database with redundant online or offline backups or other redundancies, etc., and can include a distributed database or storage network and associated processing intelligence.

The network 14 can be or include any network or combination of networks of systems or devices that communicate with one another. For example, the network 14 can be or include any one or any combination of a LAN (local area network), WAN (wide area network), telephone network, wireless network, cellular network, point-to-point network, star network, token ring network, hub network, or other appropriate configuration. The network 14 can include a TCP/IP (Transfer Control Protocol and Internet Protocol) network, such as the global internetwork of networks often referred to as the “Internet” (with a capital “I”). The Internet will be used in many of the examples herein. However, it should be understood that the networks that the disclosed implementations can use are not so limited, although TCP/IP is a frequently implemented protocol.

The user systems 12 can communicate with system 16 using TCP/IP and, at a higher network level, other common Internet protocols to communicate, such as HTTP, FTP, AFS, WAP, etc. In an example where HTTP is used, each user system 12 can include an HTTP client commonly referred to as a “web browser” or simply a “browser” for sending and receiving HTTP signals to and from an HTTP server of the system 16. Such an HTTP server can be implemented as the sole network interface 20 between the system 16 and the network 14, but other techniques can be used in addition to or instead of these techniques. In some implementations, the network interface 20 between the system 16 and the network 14 includes load sharing functionality, such as round-robin HTTP request distributors to balance loads and distribute incoming HTTP requests evenly over a number of servers. In MTS implementations, each of the servers can have access to the MTS data; however, other alternative configurations may be used instead.

The user systems 12 can be implemented as any computing device(s) or other data processing apparatus or systems usable by users to access the database system 16. For example, any of user systems 12 can be a desktop computer, a work station, a laptop computer, a tablet computer, a handheld computing device, a mobile cellular phone (for example, a “smartphone”), or any other Wi-Fi-enabled device, wireless access protocol (WAP)-enabled device, or other computing device capable of interfacing directly or indirectly to the Internet or other network. The terms “user system” and “computing device” are used interchangeably herein with one another and with the term “computer.” As described above, each user system 12 typically executes an HTTP client, for example, a web browsing (or simply “browsing”) program, such as a web browser based on the WebKit platform, Microsoft's Internet Explorer browser, Netscape's Navigator browser, Opera's browser, Mozilla's Firefox browser, or a WAP-enabled browser in the case of a cellular phone, PDA or other wireless device, or the like, allowing a user (for example, a subscriber of on-demand services provided by the system 16) of the user system 12 to access, process and view information, pages and applications available to it from the system 16 over the network 14.

Each user system 12 also typically includes one or more user input devices, such as a keyboard, a mouse, a trackball, a touch pad, a touch screen, a pen or stylus or the like, for interacting with a graphical user interface (GUI) provided by the browser on a display (for example, a monitor screen, liquid crystal display (LCD), light-emitting diode (LED) display, among other possibilities) of the user system 12 in conjunction with pages, forms, applications and other information provided by the system 16 or other systems or servers. For example, the user interface device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

The users of user systems 12 may differ in their respective capacities, and the capacity of a particular user system 12 can be entirely determined by permissions (permission levels) for the current user of such user system. For example, where a salesperson is using a particular user system 12 to interact with the system 16, that user system can have the capacities allotted to the salesperson. However, while an administrator is using that user system 12 to interact with the system 16, that user system can have the capacities allotted to that administrator. Where a hierarchical role model is used, users at one permission level can have access to applications, data, and database information accessible by a lower permission level user, but may not have access to certain applications, database information, and data accessible by a user at a higher permission level. Thus, different users generally will have different capabilities with regard to accessing and modifying application and database information, depending on the users' respective security or permission levels (also referred to as “authorizations”).

According to some implementations, each user system 12 and some or all of its components are operator-configurable using applications, such as a browser, including computer code executed using a central processing unit (CPU) such as an Intel Pentium® processor or the like. Similarly, the system 16 (and additional instances of an MTS, where more than one is present) and all of its components can be operator-configurable using application(s) including computer code to run using the processor system 17, which may be implemented to include a CPU, which may include an Intel Pentium® processor or the like, or multiple CPUs.

The system 16 includes tangible computer-readable media having non-transitory instructions stored thereon/in that are executable by or used to program a server or other computing system (or collection of such servers or computing systems) to perform some of the implementation of processes described herein. For example, computer program code 26 can implement instructions for operating and configuring the system 16 to intercommunicate and to process web pages, applications and other data and media content as described herein. In some implementations, the computer code 26 can be downloadable and stored on a hard disk, but the entire program code, or portions thereof, also can be stored in any other volatile or non-volatile memory medium or device as is well known, such as a ROM or RAM, or provided on any media capable of storing program code, such as any type of rotating media including floppy disks, optical discs, digital versatile disks (DVD), compact disks (CD), microdrives, and magneto-optical disks, and magnetic or optical cards, nanosystems (including molecular memory ICs), or any other type of computer-readable medium or device suitable for storing instructions or data. Additionally, the entire program code, or portions thereof, may be transmitted and downloaded from a software source over a transmission medium, for example, over the Internet, or from another server, as is well known, or transmitted over any other existing network connection as is well known (for example, extranet, VPN, LAN, etc.) using any communication medium and protocols (for example, TCP/IP, HTTP, HTTPS, Ethernet, etc.) as are well known. It will also be appreciated that computer code for the disclosed implementations can be realized in any programming language that can be executed on a server or other computing system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

FIG. 1B shows a block diagram of example implementations of elements of FIG. 1A and example interconnections between these elements according to some implementations. That is, FIG. 1B also illustrates environment 10, but FIG. 1B, various elements of the system 16 and various interconnections between such elements are shown with more specificity according to some more specific implementations. Additionally, in FIG. 1B, the user system 12 includes a processor system 12A, a memory system 12B, an input system 12C, and an output system 12D. The processor system 12A can include any suitable combination of one or more processors. The memory system 12B can include any suitable combination of one or more memory devices. The input system 12C can include any suitable combination of input devices, such as one or more touchscreen interfaces, keyboards, mice, trackballs, scanners, cameras, or interfaces to networks. The output system 12D can include any suitable combination of output devices, such as one or more display devices, printers, or interfaces to networks.

In FIG. 1B, the network interface 20 is implemented as a set of HTTP application (or “app”) servers 100₁-100_{N}. Each of the application servers 100₁-100_{N} (also referred to collectively herein as “the application server 100”) is configured to communicate with tenant database 22 and the tenant data 23 therein, as well as system database 24 and the system data 25 therein, to serve requests received from the user systems 12. The tenant data 23 can be divided into individual tenant storage spaces 112, which can be physically or logically arranged or divided. Within each tenant storage space 112, user storage 114 and application metadata 116 can similarly be allocated for each user. For example, a copy of a user's most recently used (MRU) items can be stored to user storage 114. Similarly, a copy of MRU items for an entire organization that is a tenant can be stored to tenant storage space 112.

The process space 28 includes system process space 102, individual tenant process spaces 104 and a tenant management process space 110. The application platform 18 includes an application setup mechanism 38 that supports application developers' creation and management of applications. Such applications and others can be saved as metadata into tenant database 22 by save routines 36 for execution by subscribers as one or more tenant process spaces 104 managed by tenant management process 110, for example. Invocations to such applications can be coded using PL/SOQL 34, which provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications can be detected by one or more system processes, which manage retrieving application metadata 116 for the subscriber making the invocation and executing the metadata as an application in a virtual machine.

The system 16 of FIG. 1B also includes a user interface (UI) 30 and an application programming interface (API) 32 to system 16 resident processes to users or developers at user systems 12. In some other implementations, the environment 10 may not have the same elements as those listed above or may have other elements instead of, or in addition to, those listed above.

Each application server 100 can be communicably coupled with tenant database 22 and system database 24, for example, having access to tenant data 23 and system data 25, respectively, via a different network connection. For example, one application server 100₁ can be coupled via the network 14 (for example, the Internet), another application server 100_{N-1} can be coupled via a direct network link, and another application server 100_{N} can be coupled by yet a different network connection. Transfer Control Protocol and Internet Protocol (TCP/IP) are examples of typical protocols that can be used for communicating between application servers 100 and the system 16. However, it will be apparent to one skilled in the art that other transport protocols can be used to optimize the system 16 depending on the network interconnections used.

In some implementations, each application server 100 is configured to handle requests for any user associated with any organization that is a tenant of the system 16. Because it can be desirable to be able to add and remove application servers 100 from the server pool at any time and for various reasons, in some implementations there is no server affinity for a user or organization to a specific application server 100. In some such implementations, an interface system implementing a load balancing function (for example, an F5 Big-IP load balancer) is communicably coupled between the application servers 100 and the user systems 12 to distribute requests to the application servers 100. In one implementation, the load balancer uses a least-connections algorithm to route user requests to the application servers 100. Other examples of load balancing algorithms, such as round robin and observed-response-time, also can be used. For example, in some instances, three consecutive requests from the same user could hit three different application servers 100, and three requests from different users could hit the same application server 100. In this manner, by way of example, system 16 can be a multi-tenant system in which system 16 handles storage of, and access to, different objects, data and applications across disparate users and organizations.

In one example storage use case, one tenant can be a company that employs a sales force where each salesperson uses system 16 to manage aspects of their sales. A user can maintain contact data, leads data, customer follow-up data, performance data, goals and progress data, etc., all applicable to that user's personal sales process (for example, in tenant database 22). In an example of a MTS arrangement, because all of the data and the applications to access, view, modify, report, transmit, calculate, etc., can be maintained and accessed by a user system 12 having little more than network access, the user can manage his or her sales efforts and cycles from any of many different user systems. For example, when a salesperson is visiting a customer and the customer has Internet access in their lobby, the salesperson can obtain critical updates regarding that customer while waiting for the customer to arrive in the lobby.

While each user's data can be stored separately from other users' data regardless of the employers of each user, some data can be organization-wide data shared or accessible by several users or all of the users for a given organization that is a tenant. Thus, there can be some data structures managed by system 16 that are allocated at the tenant level while other data structures can be managed at the user level. Because an MTS can support multiple tenants including possible competitors, the MTS can have security protocols that keep data, applications, and application use separate. Also, because many tenants may opt for access to an MTS rather than maintain their own system, redundancy, up-time, and backup are additional functions that can be implemented in the MTS. In addition to user-specific data and tenant-specific data, the system 16 also can maintain system level data usable by multiple tenants or other data. Such system level data can include industry reports, news, postings, and the like that are sharable among tenants.

In some implementations, the user systems 12 (which also can be client systems) communicate with the application servers 100 to request and update system-level and tenant-level data from the system 16. Such requests and updates can involve sending one or more queries to tenant database 22 or system database 24. The system 16 (for example, an application server 100 in the system 16) can automatically generate one or more SQL statements (for example, one or more SQL queries) designed to access the desired information. System database 24 can generate query plans to access the requested data from the database. The term “query plan” generally refers to one or more operations used to access information in a database system.

Each database can generally be viewed as a collection of objects, such as a set of logical tables, containing data fitted into predefined or customizable categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or element of a table can contain an instance of data for each category defined by the fields. For example, a CRM database can include a table that describes a customer with fields for basic contact information such as name, address, phone number, fax number, etc. Another table can describe a purchase order, including fields for information such as customer, product, sale price, date, etc. In some MTS implementations, standard entity tables can be provided for use by all tenants. For CRM database applications, such standard entities can include tables for case, account, contact, lead, and opportunity data objects, each containing pre-defined fields. As used herein, the term “entity” also may be used interchangeably with “object” and “table.”

In some MTS implementations, tenants are allowed to create and store custom objects, or may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In some implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

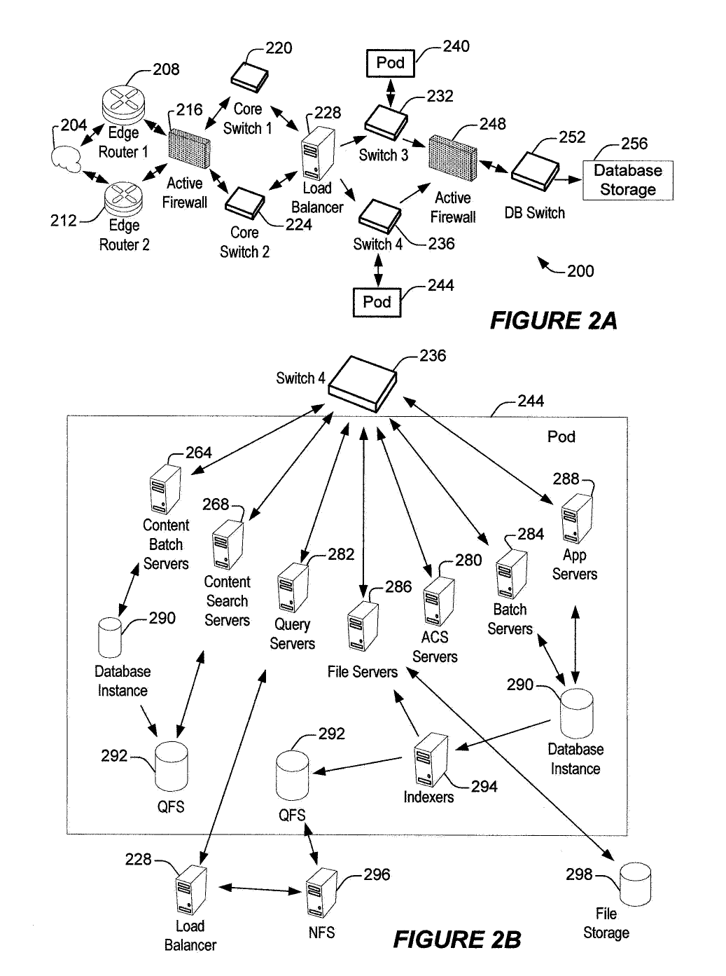

FIG. 2A shows a system diagram illustrating example architectural components of an on-demand database service environment 200 according to some implementations. A client machine communicably connected with the cloud 204, generally referring to one or more networks in combination, as described herein, can communicate with the on-demand database service environment 200 via one or more edge routers 208 and 212. A client machine can be any of the examples of user systems 12 described above. The edge routers can communicate with one or more core switches 220 and 224 through a firewall 216. The core switches can communicate with a load balancer 228, which can distribute server load over different pods, such as the pods 240 and 244. The pods 240 and 244, which can each include one or more servers or other computing resources, can perform data processing and other operations used to provide on-demand services. Communication with the pods can be conducted via pod switches 232 and 236. Components of the on-demand database service environment can communicate with database storage 256 through a database firewall 248 and a database switch 252.

As shown in FIGS. 2A and 2B, accessing an on-demand database service environment can involve communications transmitted among a variety of different hardware or software components. Further, the on-demand database service environment 200 is a simplified representation of an actual on-demand database service environment. For example, while only one or two devices of each type are shown in FIGS. 2A and 2B, some implementations of an on-demand database service environment can include anywhere from one to several devices of each type. Also, the on-demand database service environment need not include each device shown in FIGS. 2A and 2B, or can include additional devices not shown in FIGS. 2A and 2B.

Additionally, it should be appreciated that one or more of the devices in the on-demand database service environment 200 can be implemented on the same physical device or on different hardware. Some devices can be implemented using hardware or a combination of hardware and software. Thus, terms such as “data processing apparatus,” “machine,” “server” and “device” as used herein are not limited to a single hardware device, rather references to these terms can include any suitable combination of hardware and software configured to provide the described functionality.

The cloud 204 is intended to refer to a data network or multiple data networks, often including the Internet. Client machines communicably connected with the cloud 204 can communicate with other components of the on-demand database service environment 200 to access services provided by the on-demand database service environment. For example, client machines can access the on-demand database service environment to retrieve, store, edit, or process information. In some implementations, the edge routers 208 and 212 route packets between the cloud 204 and other components of the on-demand database service environment 200. For example, the edge routers 208 and 212 can employ the Border Gateway Protocol (BGP). The BGP is the core routing protocol of the Internet. The edge routers 208 and 212 can maintain a table of IP networks or ‘prefixes’, which designate network reachability among autonomous systems on the Internet.

In some implementations, the firewall 216 can protect the inner components of the on-demand database service environment 200 from Internet traffic. The firewall 216 can block, permit, or deny access to the inner components of the on-demand database service environment 200 based upon a set of rules and other criteria. The firewall 216 can act as one or more of a packet filter, an application gateway, a stateful filter, a proxy server, or any other type of firewall.

In some implementations, the core switches 220 and 224 are high-capacity switches that transfer packets within the on-demand database service environment 200. The core switches 220 and 224 can be configured as network bridges that quickly route data between different components within the on-demand database service environment. In some implementations, the use of two or more core switches 220 and 224 can provide redundancy or reduced latency.

In some implementations, the pods 240 and 244 perform the core data processing and service functions provided by the on-demand database service environment. Each pod can include various types of hardware or software computing resources. An example of the pod architecture is discussed in greater detail with reference to FIG. 2B. In some implementations, communication between the pods 240 and 244 is conducted via the pod switches 232 and 236. The pod switches 232 and 236 can facilitate communication between the pods 240 and 244 and client machines communicably connected with the cloud 204, for example via core switches 220 and 224. Also, the pod switches 232 and 236 may facilitate communication between the pods 240 and 244 and the database storage 256. In some implementations, the load balancer 228 can distribute workload between the pods 240 and 244. Balancing the on-demand service requests between the pods can assist in improving the use of resources, increasing throughput, reducing response times, or reducing overhead. The load balancer 228 may include multilayer switches to analyze and forward traffic.

In some implementations, access to the database storage 256 is guarded by a database firewall 248. The database firewall 248 can act as a computer application firewall operating at the database application layer of a protocol stack. The database firewall 248 can protect the database storage 256 from application attacks such as structure query language (SQL) injection, database rootkits, and unauthorized information disclosure. In some implementations, the database firewall 248 includes a host using one or more forms of reverse proxy services to proxy traffic before passing it to a gateway router. The database firewall 248 can inspect the contents of database traffic and block certain content or database requests. The database firewall 248 can work on the SQL application level atop the TCP/IP stack, managing applications' connection to the database or SQL management interfaces as well as intercepting and enforcing packets traveling to or from a database network or application interface.

In some implementations, communication with the database storage 256 is conducted via the database switch 252. The multi-tenant database storage 256 can include more than one hardware or software components for handling database queries. Accordingly, the database switch 252 can direct database queries transmitted by other components of the on-demand database service environment (for example, the pods 240 and 244) to the correct components within the database storage 256. In some implementations, the database storage 256 is an on-demand database system shared by many different organizations as described above with reference to FIGS. 1A and 1B.

FIG. 2B shows a system diagram further illustrating example architectural components of an on-demand database service environment according to some implementations. The pod 244 can be used to render services to a user of the on-demand database service environment 200. In some implementations, each pod includes a variety of servers or other systems. The pod 244 includes one or more content batch servers 264, content search servers 268, query servers 282, file force servers 286, access control system (ACS) servers 280, batch servers 284, and app servers 288. The pod 244 also can include database instances 290, quick file systems (QFS) 292, and indexers 294. In some implementations, some or all communication between the servers in the pod 244 can be transmitted via the switch 236.

In some implementations, the app servers 288 include a hardware or software framework dedicated to the execution of procedures (for example, programs, routines, scripts) for supporting the construction of applications provided by the on-demand database service environment 200 via the pod 244. In some implementations, the hardware or software framework of an app server 288 is configured to execute operations of the services described herein, including performance of the blocks of various methods or processes described herein. In some alternative implementations, two or more app servers 288 can be included and cooperate to perform such methods, or one or more other servers described herein can be configured to perform the disclosed methods.

The content batch servers 264 can handle requests internal to the pod. Some such requests can be long-running or not tied to a particular customer. For example, the content batch servers 264 can handle requests related to log mining, cleanup work, and maintenance tasks. The content search servers 268 can provide query and indexer functions. For example, the functions provided by the content search servers 268 can allow users to search through content stored in the on-demand database service environment. The file force servers 286 can manage requests for information stored in the Fileforce storage 298. The Fileforce storage 298 can store information such as documents, images, and basic large objects (BLOBs). By managing requests for information using the file force servers 286, the image footprint on the database can be reduced. The query servers 282 can be used to retrieve information from one or more file systems. For example, the query system 282 can receive requests for information from the app servers 288 and transmit information queries to the NFS 296 located outside the pod.

The pod 244 can share a database instance 290 configured as a multi-tenant environment in which different organizations share access to the same database. Additionally, services rendered by the pod 244 may call upon various hardware or software resources. In some implementations, the ACS servers 280 control access to data, hardware resources, or software resources. In some implementations, the batch servers 284 process batch jobs, which are used to run tasks at specified times. For example, the batch servers 284 can transmit instructions to other servers, such as the app servers 288, to trigger the batch jobs.

In some implementations, the QFS 292 is an open source file system available from Sun Microsystems® of Santa Clara, Calif. The QFS can serve as a rapid-access file system for storing and accessing information available within the pod 244. The QFS 292 can support some volume management capabilities, allowing many disks to be grouped together into a file system. File system metadata can be kept on a separate set of disks, which can be useful for streaming applications where long disk seeks cannot be tolerated. Thus, the QFS system can communicate with one or more content search servers 268 or indexers 294 to identify, retrieve, move, or update data stored in the network file systems 296 or other storage systems.

In some implementations, one or more query servers 282 communicate with the NFS 296 to retrieve or update information stored outside of the pod 244. The NFS 296 can allow servers located in the pod 244 to access information to access files over a network in a manner similar to how local storage is accessed. In some implementations, queries from the query servers 282 are transmitted to the NFS 296 via the load balancer 228, which can distribute resource requests over various resources available in the on-demand database service environment. The NFS 296 also can communicate with the QFS 292 to update the information stored on the NFS 296 or to provide information to the QFS 292 for use by servers located within the pod 244.

In some implementations, the pod includes one or more database instances 290. The database instance 290 can transmit information to the QFS 292. When information is transmitted to the QFS, it can be available for use by servers within the pod 244 without using an additional database call. In some implementations, database information is transmitted to the indexer 294. Indexer 294 can provide an index of information available in the database 290 or QFS 292. The index information can be provided to file force servers 286 or the QFS 292.

### II. Enterprise Social Networking

As initially described above, in some implementations, some of the methods, processes, devices and systems described herein can implement, or be used in the context of, enterprise social networking Some online enterprise social networks can be implemented in various settings, including businesses, organizations and other enterprises (all of which are used interchangeably herein). For instance, an online enterprise social network can be implemented to connect users within a business corporation, partnership or organization, or a group of users within such an enterprise. For instance, Chatter® can be used by users who are employees in a business organization to share data, communicate, and collaborate with each other for various enterprise-related purposes. Some of the disclosed methods, processes, devices, systems and computer-readable storage media described herein can be configured or designed for use in a multi-tenant database environment, such as described above with respect to system 16. In an example implementation, each organization or a group within the organization can be a respective tenant of the system.

In some implementations, each user of the database system 16 is associated with a “user profile.” A user profile refers generally to a collection of data about a given user. The data can include general information, such as a name, a title, a phone number, a photo, a biographical summary, or a status (for example, text describing what the user is currently doing, thinking or expressing). The data associated with a user profile also can include various permissions defining the ability of the user to interact with various data objects. In implementations in which there are multiple tenants, a user is typically associated with a particular tenant (or “organization”). For example, a user could be a salesperson of an organization that is a tenant of the database system 16.

A “group” generally refers to a collection of users within an organization. In some implementations, a group can be defined as users with the same or a similar attribute, or by membership or subscription. Groups can have various visibilities to users within an enterprise social network. For example, some groups can be private while others can be public. In some implementations, to become a member within a private group, and to have the capability to publish and view feed items on the group's group feed, a user must request to be subscribed to the group (and be accepted by, for example, an administrator or owner of the group), be invited to subscribe to the group (and accept), or be directly subscribed to the group (for example, by an administrator or owner of the group). In some implementations, any user within the enterprise social network can subscribe to or follow a public group (and thus become a “member” of the public group) within the enterprise social network.

A “record” generally refers to a data entity, such as an instance of a data object created by a user or a group of users of the database system 16. Such records can include, for example, data objects representing and maintaining data for accounts (for example, representing a business relationship with another enterprise). In some implementations, each record is assigned a record type, which can be identified by a RecordTypeID. Examples of account record types include: customers (for example, users or organizations who pay the enterprise money), customer support (for example, users or organizations who pay the enterprise money to support them), households (for example, organizations in a business-to-consumer model), partners (for example, organizations who pay the enterprise money and to whom the enterprise pays money), suppliers (for example, organizations to whom the enterprise pays money), and other organizations including organizations with whom no money is exchanged. Other examples of record types in addition to accounts can include cases, opportunities, leads, projects, contracts, orders, pricebooks, products, solutions, reports and forecasts, among other possibilities.

For example, an account record can be for a business partner or potential business partner, an actual or potential customer, an actual or potential supplier, an actual or potential distributor, or a client, among other possibilities. A record such as an account can include information describing an entire enterprise or subsidiary of an enterprise. As another example, a record such as an account record itself can include a number of records. For example, a customer account can include opportunities, contracts, and orders. As another example, a partner record can include a project or contract that a user or group of users is working on with an existing partner, or a project or contract that the user is trying to obtain with a partner. A record also can include various data fields and controls that are defined by the structure or layout of the object (for example, fields of certain data types and purposes). A record also can have custom fields defined by a user or organization. A field can include (or include a link to) another record, thereby providing a parent-child relationship between the records.

Records also can have various visibilities to users within an enterprise social network. For example, some records can be private while others can be public. In some implementations, to access a private record, and to have the capability to publish and view feed items on the record's record feed, a user must request to be subscribed to the record (and be accepted by, for example, an administrator or owner of the record), be invited to subscribe to the record (and accept), be directly subscribed to the record or be shared the record (for example, by an administrator or owner of the record). In some implementations, any user within the enterprise social network can subscribe to or follow a public record within the enterprise social network.

In some online enterprise social networks, users also can follow one another by establishing “links” or “connections” with each other, sometimes referred to as “friending” one another. By establishing such a link, one user can see information generated by, generated about, or otherwise associated with another user. For instance, a first user can see information posted by a second user to the second user's profile page. In one example, when the first user is following the second user, the first user's news feed can receive a post from the second user submitted to the second user's profile feed.

In some implementations, users can access one or more enterprise network feeds (also referred to herein simply as “feeds”), which include publications presented as feed items or entries in the feed. A network feed can be displayed in a graphical user interface (GUI) on a display device such as the display of a user's computing device as described above. The publications can include various enterprise social network information or data from various sources and can be stored in the database system 16, for example, in tenant database 22. In some implementations, feed items of information for or about a user can be presented in a respective user feed, feed items of information for or about a group can be presented in a respective group feed, and feed items of information for or about a record can be presented in a respective record feed. A second user following a first user, a first group, or a first record can automatically receive the feed items associated with the first user, the first group or the first record for display in the second user's news feed. In some implementations, a user feed also can display feed items from the group feeds of the groups the respective user subscribes to, as well as feed items from the record feeds of the records the respective user subscribes to.

The term “feed item” (or feed element) refers to an item of information, which can be viewable in a feed. Feed items can include publications such as messages (for example, user-generated textual posts or comments), files (for example, documents, audio data, image data, video data or other data), and “feed-tracked” updates associated with a user, a group or a record (feed-tracked updates are described in greater detail below). A feed item, and a feed in general, can include combinations of messages, files and feed-tracked updates. Documents and other files can be included in, linked with, or attached to a post or comment. For example, a post can include textual statements in combination with a document. The feed items can be organized in chronological order or another suitable or desirable order (which can be customizable by a user) when the associated feed is displayed in a graphical user interface (GUI), for instance, on the user's computing device.

Messages such as posts can include alpha-numeric or other character-based user inputs such as words, phrases, statements, questions, emotional expressions, or symbols. In some implementations, a comment can be made on any feed item. In some implementations, comments are organized as a list explicitly tied to a particular feed item such as a feed-tracked update, post, or status update. In some implementations, comments may not be listed in the first layer (in a hierarchal sense) of feed items, but listed as a second layer branching from a particular first layer feed item. In some implementations, a “like” or “dislike” also can be submitted in response to a particular post, comment or other publication.

A “feed-tracked update,” also referred to herein as a “feed update,” is another type of publication that may be presented as a feed item and generally refers to data representing an event. A feed-tracked update can include text generated by the database system in response to the event, to be provided as one or more feed items for possible inclusion in one or more feeds. In one implementation, the data can initially be stored by the database system in, for example, tenant database 22, and subsequently used by the database system to create text for describing the event. Both the data and the text can be a feed-tracked update, as used herein. In some implementations, an event can be an update of a record and can be triggered by a specific action by a user. Which actions trigger an event can be configurable. Which events have feed-tracked updates created and which feed updates are sent to which users also can be configurable. Messages and feed updates can be stored as a field or child object of a record. For example, the feed can be stored as a child object of the record.

As described above, a network feed can be specific to an individual user of an online social network. For instance, a user news feed (or “user feed”) generally refers to an aggregation of feed items generated for a particular user, and in some implementations, is viewable only to the respective user on a home page of the user. In some implementations a user profile feed (also referred to as a “user feed”) is another type of user feed that refers to an aggregation of feed items generated by or for a particular user, and in some implementations, is viewable only by the respective user and other users following the user on a profile page of the user. As a more specific example, the feed items in a user profile feed can include posts and comments that other users make about or send to the particular user, and status updates made by the particular user. As another example, the feed items in a user profile feed can include posts made by the particular user and feed-tracked updates initiated based on actions of the particular user.

As is also described above, a network feed can be specific to a group of enterprise users of an online enterprise social network. For instance, a group news feed (or “group feed”) generally refers to an aggregation of feed items generated for or about a particular group of users of the database system 16 and can be viewable by users following or subscribed to the group on a profile page of the group. For example, such feed items can include posts made by members of the group or feed-tracked updates about changes to the respective group (or changes to documents or other files shared with the group). Members of the group can view and post to a group feed in accordance with a permissions configuration for the feed and the group. Publications in a group context can include documents, posts, or comments. In some implementations, the group feed also includes publications and other feed items that are about the group as a whole, the group's purpose, the group's description, a status of the group, and group records and other objects stored in association with the group. Threads of publications including updates and messages, such as posts, comments, likes, etc., can define conversations and change over time. The following of a group allows a user to collaborate with other users in the group, for example, on a record or on documents or other files (which may be associated with a record).

As is also described above, a network feed can be specific to a record in an online enterprise social network. For instance, a record news feed (or “record feed”) generally refers to an aggregation of feed items about a particular record in the database system 16 and can be viewable by users subscribed to the record on a profile page of the record. For example, such feed items can include posts made by users about the record or feed-tracked updates about changes to the respective record (or changes to documents or other files associated with the record). Subscribers to the record can view and post to a record feed in accordance with a permissions configuration for the feed and the record. Publications in a record context also can include documents, posts, or comments. In some implementations, the record feed also includes publications and other feed items that are about the record as a whole, the record's purpose, the record's description, and other records or other objects stored in association with the record. Threads of publications including updates and messages, such as posts, comments, likes, etc., can define conversations and change over time. The following of a record allows a user to track the progress of that record and collaborate with other users subscribing to the record, for example, on the record or on documents or other files associated with the record.

In some implementations, data is stored in database system 16, including tenant database 22, in the form of “entity objects” (also referred to herein simply as “entities”). In some implementations, entities are categorized into “Records objects” and “Collaboration objects.” In some such implementations, the Records object includes all records in the enterprise social network. Each record can be considered a sub-object of the overarching Records object. In some implementations, Collaboration objects include, for example, a “Users object,” a “Groups object,” a “Group-User relationship object,” a “Record-User relationship object” and a “Feed Items object.”

In some implementations, the Users object is a data structure that can be represented or conceptualized as a “Users Table” that associates users to information about or pertaining to the respective users including, for example, metadata about the users. In some implementations, the Users Table includes all of the users within an organization. In some other implementations, there can be a Users Table for each division, department, team or other sub-organization within an organization. In implementations in which the organization is a tenant of a multi-tenant enterprise social network platform, the Users Table can include all of the users within all of the organizations that are tenants of the multi-tenant enterprise social network platform. In some implementations, each user can be identified by a user identifier (“UserID”) that is unique at least within the user's respective organization. In some such implementations, each organization also has a unique organization identifier (“OrgID”).

In some implementations, the Groups object is a data structure that can be represented or conceptualized as a “Groups Table” that associates groups to information about or pertaining to the respective groups including, for example, metadata about the groups. In some implementations, the Groups Table includes all of the groups within the organization. In some other implementations, there can be a Groups Table for each division, department, team or other sub-organization within an organization. In implementations in which the organization is a tenant of a multi-tenant enterprise social network platform, the Groups Table can include all of the groups within all of the organizations that are tenants of the multitenant enterprise social network platform. In some implementations, each group can be identified by a group identifier (“GroupID”) that is unique at least within the respective organization.

In some implementations, the database system 16 includes a “Group-User relationship object.” The Group-User relationship object is a data structure that can be represented or conceptualized as a “Group-User Table” that associates groups to users subscribed to the respective groups. In some implementations, the Group-User Table includes all of the groups within the organization. In some other implementations, there can be a Group-User Table for each division, department, team or other sub-organization within an organization. In implementations in which the organization is a tenant of a multi-tenant enterprise social network platform, the Group-User Table can include all of the groups within all of the organizations that are tenants of the multitenant enterprise social network platform.

In some implementations, the Records object is a data structure that can be represented or conceptualized as a “Records Table” that associates records to information about or pertaining to the respective records including, for example, metadata about the records. In some implementations, the Records Table includes all of the records within the organization. In some other implementations, there can be a Records Table for each division, department, team or other sub-organization within an organization. In implementations in which the organization is a tenant of a multi-tenant enterprise social network platform, the Records Table can include all of the records within all of the organizations that are tenants of the multitenant enterprise social network platform. In some implementations, each record can be identified by a record identifier (“RecordID”) that is unique at least within the respective organization.

In some implementations, the database system 16 includes a “Record-User relationship object.” The Record-User relationship object is a data structure that can be represented or conceptualized as a “Record-User Table” that associates records to users subscribed to the respective records. In some implementations, the Record-User Table includes all of the records within the organization. In some other implementations, there can be a Record-User Table for each division, department, team or other sub-organization within an organization. In implementations in which the organization is a tenant of a multi-tenant enterprise social network platform, the Record-User Table can include all of the records within all of the organizations that are tenants of the multitenant enterprise social network platform.

In some implementations, the database system 16 includes a “Feed Items object.” The Feed items object is a data structure that can be represented or conceptualized as a “Feed Items Table” that associates users, records and groups to posts, comments, documents or other publications to be displayed as feed items in the respective user feeds, record feeds and group feeds, respectively. In some implementations, the Feed Items Table includes all of the feed items within the organization. In some other implementations, there can be a Feed Items Table for each division, department, team or other sub-organization within an organization. In implementations in which the organization is a tenant of a multi-tenant enterprise social network platform, the Feed Items Table can include all of the feed items within all of the organizations that are tenants of the multitenant enterprise social network platform.

Enterprise social network news feeds are different from typical consumer-facing social network news feeds (for example, FACEBOOK®) in many ways, including in the way they prioritize information. In consumer-facing social networks, the focus is generally on helping the social network users find information that they are personally interested in. But in enterprise social networks, it can, in some instances, applications, or implementations, be desirable from an enterprise's perspective to only distribute relevant enterprise-related information to users and to limit the distribution of irrelevant information. In some implementations, relevant enterprise-related information refers to information that would be predicted or expected to benefit the enterprise by virtue of the recipients knowing the information, such as an update to a database record maintained by or on behalf of the enterprise. Thus, the meaning of relevance differs significantly in the context of a consumer-facing social network as compared with an employee-facing or organization member-facing enterprise social network.

In some implementations, when data such as posts or comments from one or more enterprise users are submitted to a network feed for a particular user, group, record or other object within an online enterprise social network, an email notification or other type of network communication may be transmitted to all users following the respective user, group, record or object in addition to the inclusion of the data as a feed item in one or more user, group, record or other feeds. In some online enterprise social networks, the occurrence of such a notification is limited to the first instance of a published input, which may form part of a larger conversation. For instance, a notification may be transmitted for an initial post, but not for comments on the post. In some other implementations, a separate notification is transmitted for each such publication, such as a comment on a post.

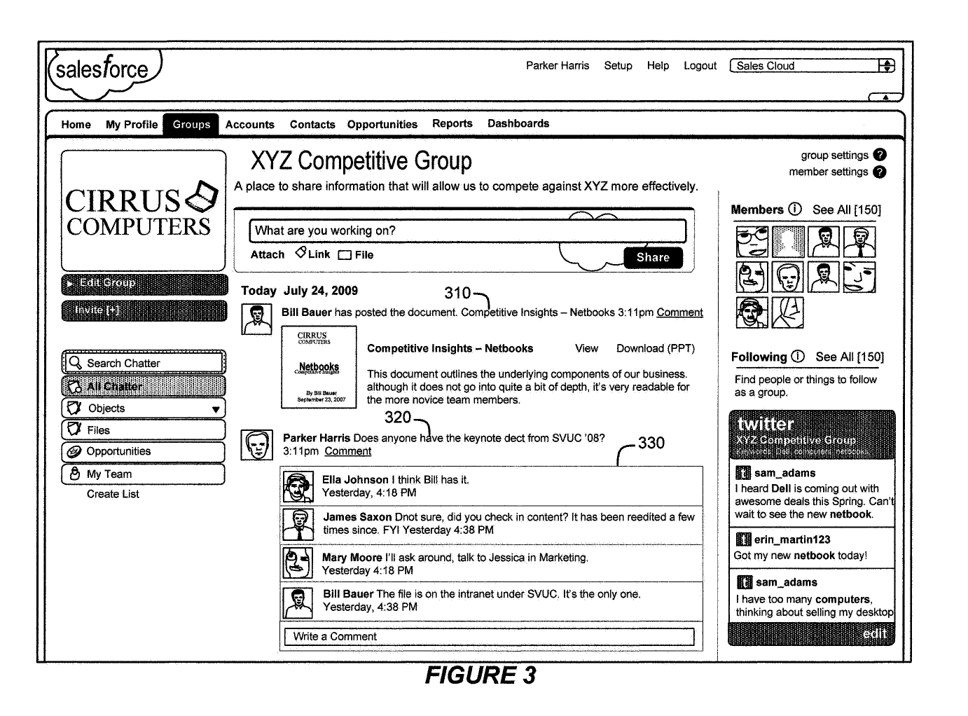

FIG. 3 shows an example of a group feed on a group profile page according to some implementations. As shown, a feed item 310 shows that a user has posted a document to the group feed. The text “Bill Bauer has posted the document Competitive Insights” can be generated by the database system in a similar manner as feed-tracked updates about a record being changed. A feed item 320 shows a post to the group, along with comments 330 from Ella Johnson, James Saxon, Mary Moore and Bill Bauer.

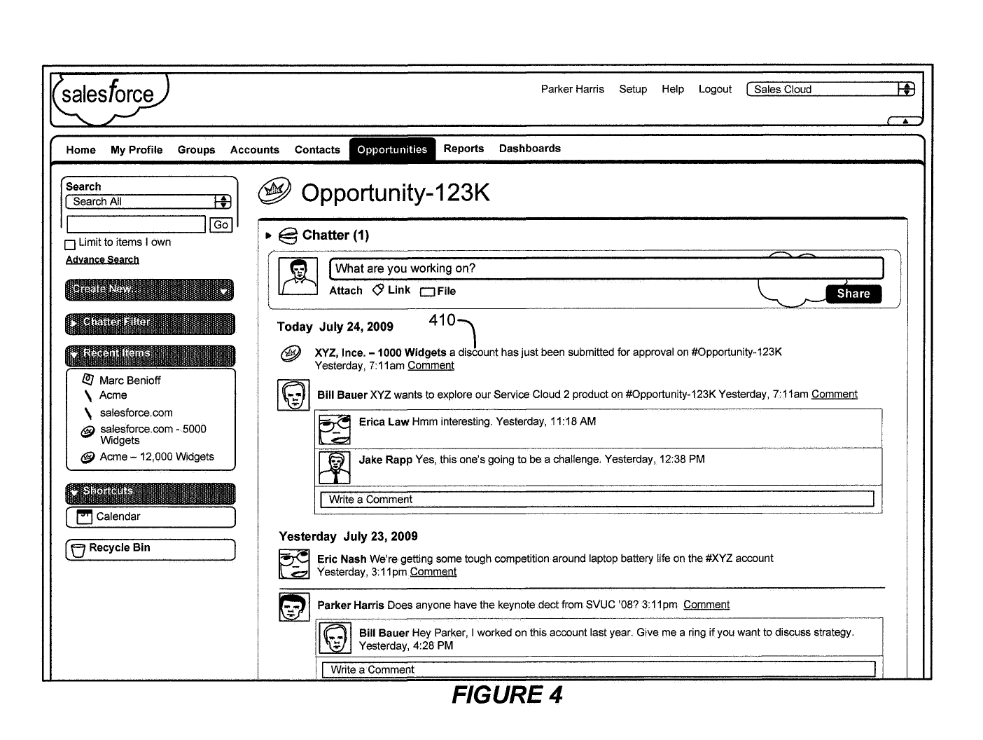

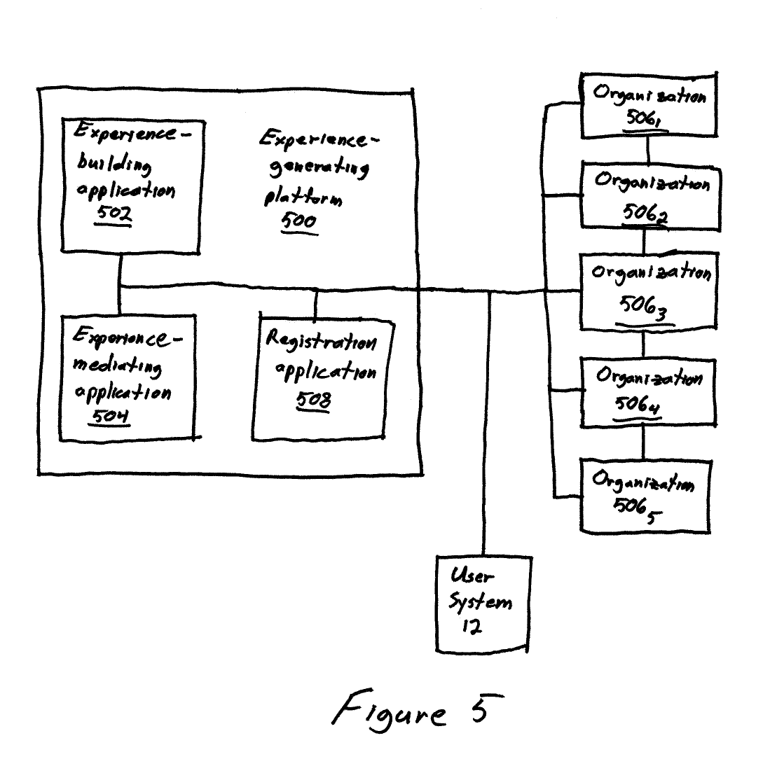

FIG. 4 shows an example of a record feed on a record profile page according to some implementations. The record feed includes a feed-tracked update, a post, and comments. Feed item 410 shows a feed-tracked update based on the event of submitting a discount for approval. Other feed items show posts, for example, from Bill Bauer, made to the record and comments, for example, from Erica Law and Jake Rapp, made on the posts.

### III. Customized User Experiences

As described above, in some implementations, the database system 16 includes application servers 100₁-100_{N}. In some implementations, one or more of the application servers 100₁-100_{N} implement or host a core application for providing various on-demand or cloud-computing services described herein. In some implementations, one or more of the same or different application servers 100₁-100_{N} implement or host an experience-generating platform (or “application”). In some implementations, the experience-generating platform executes in conjunction with the core application. In some implementations, the core application includes the experience-generating platform; for example, the experience-generating platform executes within the core application. In some other implementations, the experience-generating platform executes outside of the core application. In some implementations, the experience-generating platform executes within one or more different servers than the core application.

In some implementations, the experience-generating platform enables an organization to provide or facilitate a customized 1:1 custom experience to a customer user across a number of various channels and devices. For example, such channels can include mobile channels such as text (for example, a short message service (SMS)) messages, multimedia (for example, a multimedia messaging service (MMS)) messages and other notifications; social networking channels such as information feeds or other notifications; email channels such as emails or email digests; and various other suitable or desirable channels of communication.

In some implementations, the experience-generating platform includes an experience-building application and an experience-mediating application. In some implementations, the experience-building application can execute within one or more of the same servers as the experience-mediating application. In some other implementations, the experience-building application can execute within one or more different servers than the experience-mediating application. In some such implementations, the experience-building application and the experience-mediating application are capable of communicating with one another, as well as with one or more databases within the database system 16.

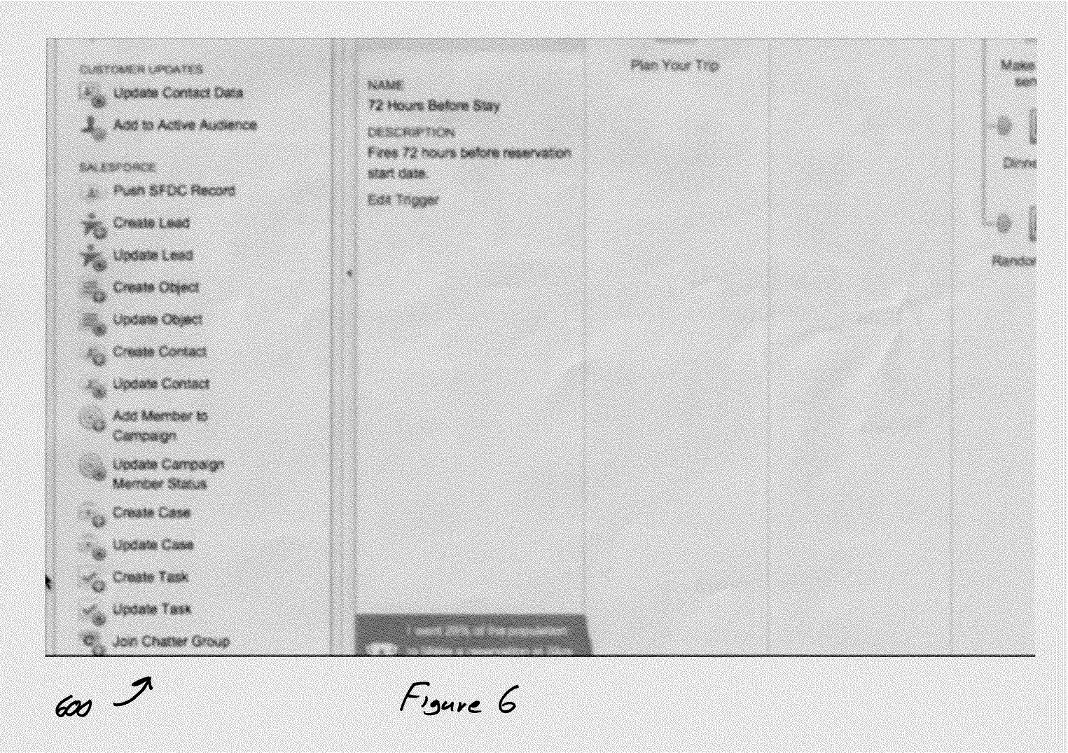

FIG. 5 shows an example of an experience-generating platform 500 according to some implementations. The experience-generating platform 500 includes an experience-building application 502 and an experience-mediating application 504. In some implementations, the experience-generating platform 500 can be communicably coupled with any number of organizations 506_{N}, including a first organization 506₁, a second organization 506₂, a third organization 506₃, a fourth organization 506₄ and a fifth organization 506₅. For example, the experience-generating platform 500 can be coupled via one or more wired or wireless networks, such as the network 14 described above with reference to FIG. 1A, to each of the organizations 506_{N}. Additionally, each of the organizations 506_{N} can be coupled via one or more wired or wireless networks with one or more other ones of the organizations 506_{N}, whether directly via one or more networks or indirectly via the database system 16 in conjunction with one or more networks.

In some implementations, the experience-generating platform 500 is coupled to a server or database of each of the organizations 506_{N}. In some such implementations, the server or database of each of the organizations 506_{N} may not reside in the same physical location as an office or other location of the respective organization in which an administrator, manager or other employee accesses and interacts with the experience-generating platform 500.

In some other implementations, one or more of the organizations 506_{N} may not include or not utilize its own server or database. In some such implementations, such organizations 506_{N} may simply include client computing devices, such as the user systems 12 described above with reference to FIG. 1A, to interact with the enterprise-generating platform 500, and more generally, the database system 16. In some such implementations, one or more of the organizations 506_{N} can utilize any of the cloud-based services, databases or platforms described herein rather than store or host such functionality or information locally in a physical location of the organization.

As described above, the user systems 12 can be implemented as any computing device(s) or other data processing apparatus or system usable by users to access the database system 16 and the experience-generating platform 500. For example, any of user systems 12 can be a desktop computer, a work station, a laptop computer, a tablet computer, a handheld computing device, a mobile cellular phone (for example, a “smartphone”), or any other Wi-Fi-enabled device, wireless access protocol (WAP)-enabled device, or other computing device capable of interfacing directly or indirectly to the Internet or other network. The terms “user system” and “computing device” are used interchangeably herein with one another and with the term “computer.”

The experience-building application 502 is configured to receive experience data from each of the organizations 506_{N}. In some implementations, the experience data is used to generate, define or modify an associated custom experience for a customer. In some implementations, each experience defined by an organization for a customer includes at least one activity and at least one trigger associated with a start or an end of a corresponding activity.

In some implementations, each of the organizations 506_{N} desiring to access or use the experience-building application 502 can register with the database system 16. For example, the experience-generating platform 500 can include a registration application 508 configured to receive a request from an organization to register with the database system 16, or more specifically, with the experience-generating platform 500. In response to the request, the registration application 508 is configured to register the requesting organization with the database system 16. In some implementations, the registration application 508 is configured to generate, or cause to be generated, an organization data object for the respective registered organization and to store the organization data object in the database system 16. In some such implementations, the organization data object includes identifying and other information about or of the respective organization.

In some implementations, the experience-building application 502 is configured to provide one or more interfaces to each of the organizations 506_{N}, for example, to a computing device used by an employee of the organization. In some implementations, each of the interfaces can be a user interface (UI) generated and communicated to the computing device as a web UI, web application or website. In some implementations, one or more of the interfaces enable the respective organization or employee to enter, upload, modify, select or access information or data about a customer for whom an experience is generated or for whom an experience is to be generated, as well as to enter, upload, modify, select or access information or data about the associated experience. Such information about the customer or experience can be used to generate a new customized experience or modify an existing custom experience for the customer using the experience-building application 502.

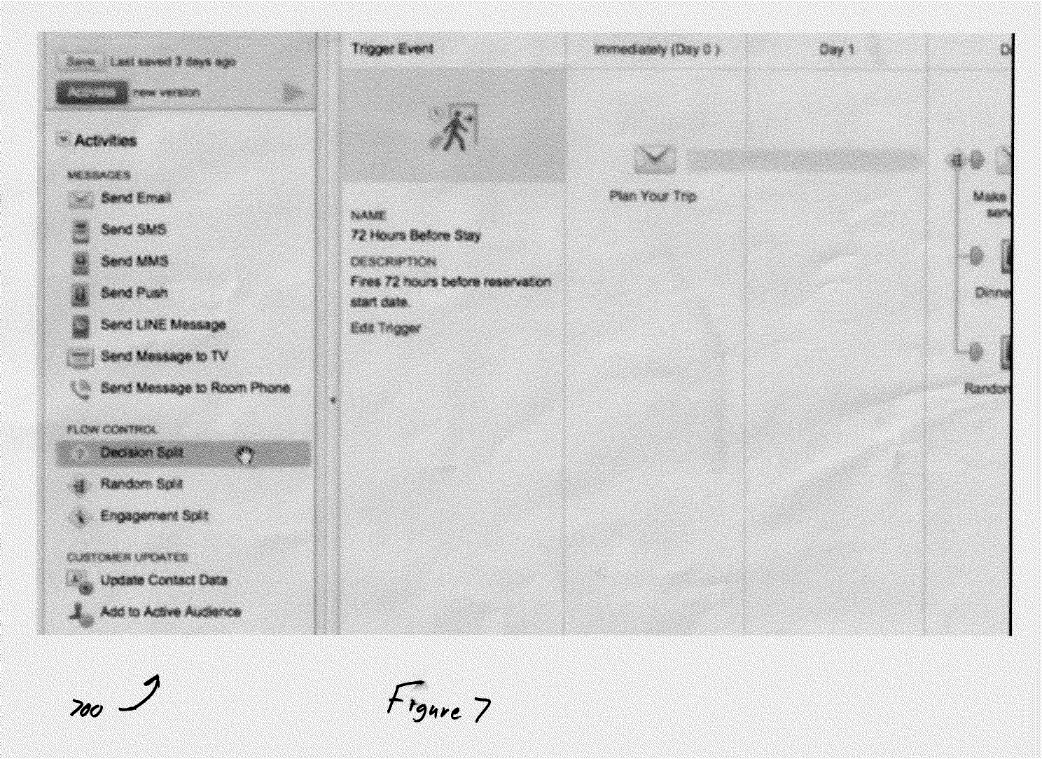

FIG. 6 shows an example of an interface 600 provided by the experience-building application 502 for enabling an organization to generate a customized experience for a customer according to some implementations. For example, the interface 600 (or another suitable or desirable interface) can enable an employee of the organization to enter, upload, modify, select, define or access (hereinafter referred to collectively as “define”) identifying information about the customer. For example, the identifying information can include contact data about the customer such as, for example, a name of the customer, an organization the customer works for (an “employer”), a driver's license, a passport, an identification card, a residential address, an employer address, a mobile telephone number, a home telephone (“landline”) telephone number, an email address, a security code, a password, a fingerprint, a digital version of a written signature, or a heart rate signature, among other suitable or desirable identifying information. In some implementations, the interface also can enable an employee to upload payment information for the customer such as, for example, a credit card number, a debit card number, a checking account number, a savings account number, a PayPal account number, or other third-party payment service information such as a mobile payments service information. In some implementations, the interface also can enable an employee to upload travel information for the customer such as, for example, an airline boarding pass or a ground transportation (for example, a bus or train) boarding pass or ticket. In some implementations, the interface also can enable an employee to upload reservation information for the customer such as, for example, a reservation for a flight, a reservation for ground transportation, a reservation for a rental car, a reservation for a hotel or other lodging, a registration for a conference (such as a business conference), a reservation for a restaurant (for example, a dinner reservation), a reservation for an appointment (such as with another organization, doctor, or other party), or a reservation for another suitable or desirable engagement (or “activity) such as a concert, a show, or other form of entertainment.

Additionally or alternatively, in some implementations the interface can enable the respective organization or employee to access, via the experience-building application 502, information about the customer stored in the database system 16. For example, in some instances, the customer also may be a registered user of the database system 16, and in some such instances, a user of a social networking system implemented by the database system 16. In such implementations, database system 16 may already store a user profile (for example, as a user data object) associated with the user that includes some or all of the information described above about the customer. Such accessed information about the customer can be used to generate a customized experience for the customer using the experience-building application 502. Additionally or alternatively, the experience-building application 502 can create a new user data object for the customer or to update an existing user data object.

Additionally or alternatively, in some implementations the interface can enable the respective organization or employee to access, via the experience-building application 502, information about the customer stored in a database of a respective one of the other organizations 506_{N} registered with the experience-generating platform 500. Such accessed information about the customer can be used to generate a customized experience for the customer using the experience-building application 502. For example, in some implementations, some or all of the organizations 506_{N} can agree to form various partnerships with other ones of the organizations 506_{N}.

For example, the enterprise-building application 504 can receive a request from the one of the organization 506_{N} requesting to subscribe to data published by another one of the organizations 506_{N}. For example, some or all of the organizations 506_{N} can enter or receive information about a customer including identifying information or preferences for the customer as well as event data (described below) associated with the user. The organization can then publish such information or data to the enterprise-platform 500 for storage in the database system 16. In some such implementations, when an organization is subscribed to information published by another organization, the experience-generating platform 500 can automatically push such information to the subscribed organization, for example, in the form of a notification to a computing device, server or database of the organization. In some such implementations, the notification is provided to a computing device currently being used or viewed by an employee of the organization such that the employee can facilitate, customize or modify an activity associated with the customer. In some other implementations, the subscribing organization can request, whether on demand or periodically, information or data published by the publishing organization.

Additionally, in some implementations, the experience-generating platform 500 enables a customer to subscribe to information published by an organization. Additionally, in some implementations, the experience-generating platform 500 enables an organization to subscribe to information published or otherwise entered or uploaded by a customer, for example, using a mobile or other computing device of the customer. In some implementations, a subscribing organization or customer can select which published information to receive from a respective organization, when to be provided with such information (for example, as a push notification in real-time, periodically, or on demand), where to receive such information (for example, on one or more mobile devices or other computing devices associated with the customer), and how to receive such information (for example, via one or more particular preferred or available channels as described below).

In some implementations, a customer who has opted in to an organization from which to receive an experience, or opted in to an experience generated (or to be generated) by the respective organization, is automatically subscribed to the organization. In some implementations, the organization which generates and facilitates a particular custom experience for a customer selects the channel by which to guide the customer during the customer's experience. Additionally or alternatively, the organization can provide a set or menu of channels from which the customer can select one or more of. In some implementations, when the experience-generating platform 500, or an organization associated with a current experience of a customer, detects or receives an indication that a particular channel (for example, a preferred channel selected by the customer) is not working or is inoperable, it can select a secondary channel that is operable. Furthermore, as indicated above, the channels can be used in conjunction with any number of various computing devices the customer may use. For example, during various different portions, stages, time periods, activities or aspects of a customer's experience or during different experiences of an amalgamation of experiences (as described herein), the customer may desire to receive information using different channels or different devices based on, for example, what is operational from a technological perspective or what is convenient or desirable from the customer's perspective.

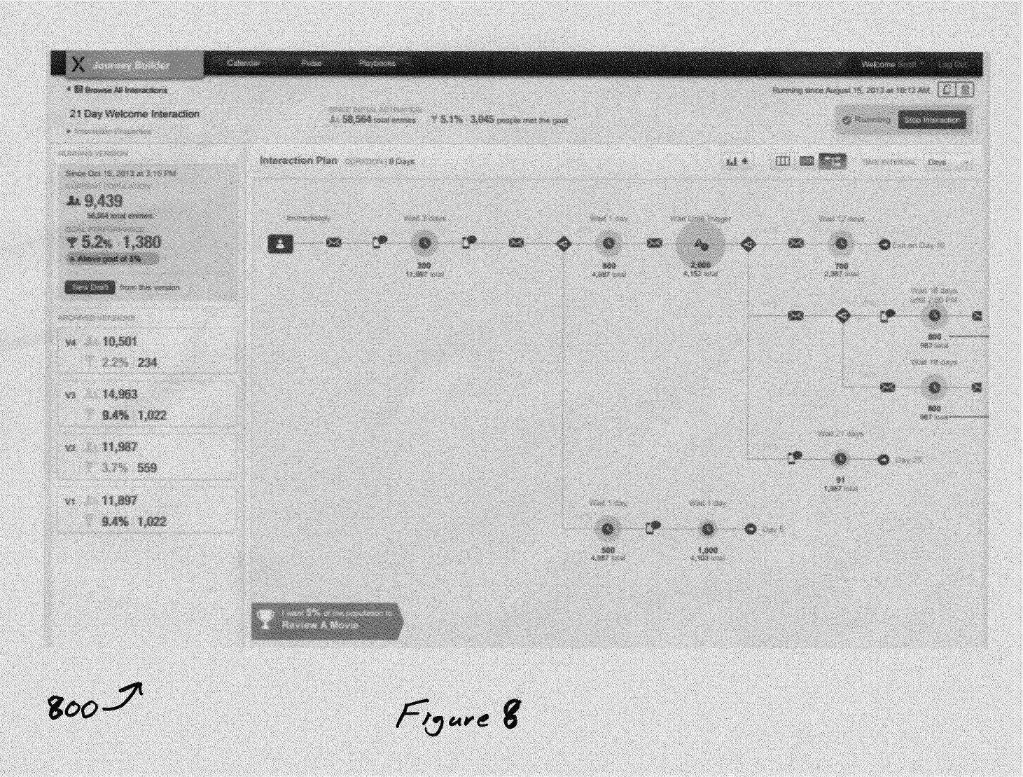

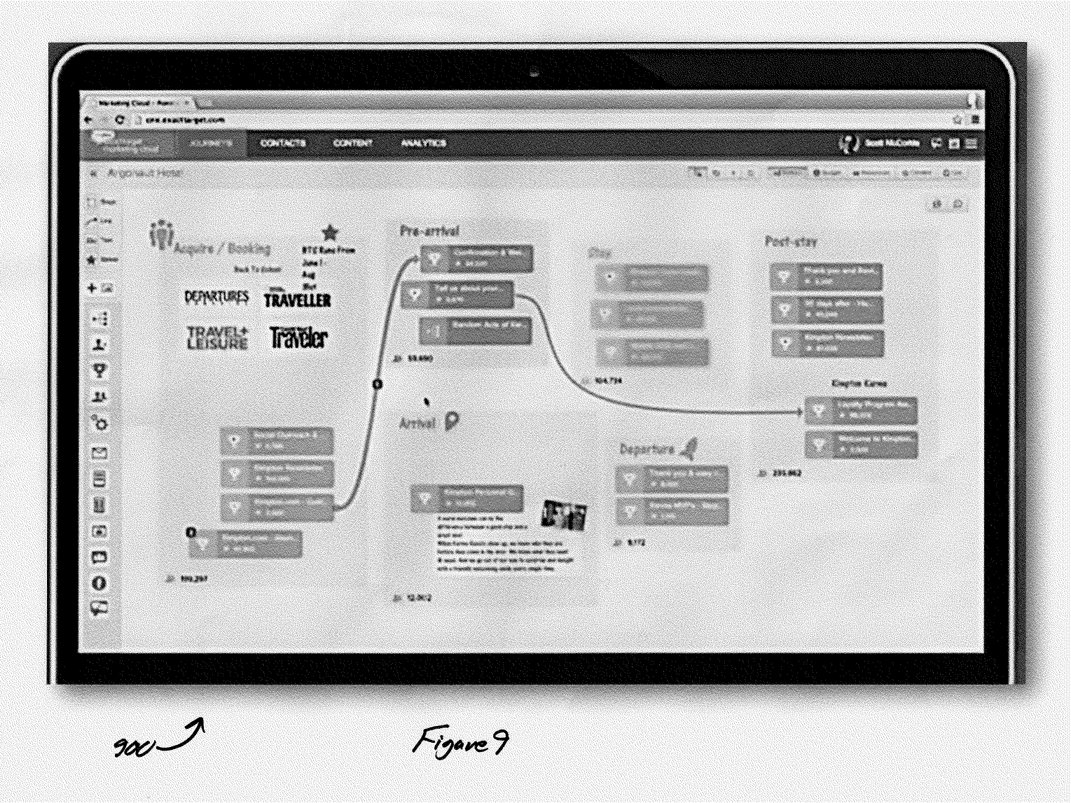

FIG. 7 shows an example of an interface 700 provided by the experience-building application 502 for enabling an organization to generate a customized experience for a customer according to some implementations. For example, the interface 700 or another interface can enable an employee of the organization to define activity data for one or more activities to be included in a custom experience generated for a customer. Additionally, in some implementations, the interface 700 or another interface can enable an employee of the organization to define trigger data for one or more triggers associated with each of one or more of the activities, and to tie such trigger data to the corresponding activity data. FIG. 8 shows an example of a more specific interface 800 provided by the experience-building application 502 for enabling an organization to define and associate trigger data for a custom experience according to some implementations. In some other implementations, the experience-building application 502 itself can generate trigger data for one or more of the triggers determined for one or more of the activities.

The types of activities desirably associated or included with various experiences can vary based on the needs of the customer or the organization or both. For example, an organization such as an airline can define an experience associated with a flight. Some examples of some activities that can be associated with a flight include checking in for the flight (a “check-in” activity); passing through a security checkpoint (a “security,” “verification” or “authentication” activity); navigating or guiding the customer through the airport, for example, to a gate, a customer service counter, a club, or a restaurant (a “navigation” or “guidance” activity); passing through the gate and onto the plane; the flight itself; and landing at a destination airport.

As another example, an organization such as a car rental organization can define an experience associated with a car rental. Some examples of some activities that can be associated with a car rental include getting to the car rental location, for example, via a shuttle bus, taxi or other ground transportation service (such as from an airport or a customer's home, hotel or other current location); navigating the customer to his rented car; unlocking the car, for example, using an OBD system; and providing navigation to a destination, for example, such as a hotel or other lodging provider, a conference, or other attraction.

As another example, an organization such as a hotel, a peer-to-peer lodging provider (such as Airbnb, Inc) or other lodging provider can define an experience associated with lodging. Some examples of some activities that can be associated with a hotel, for example, can include arriving at the hotel; checking into the hotel; navigating the customer to his room; using an authentication device or application to unlock the room; and providing various recommendations (for example, for dinner or site-seeing) or services to the customer (for example, business services, spa services or other customer services).

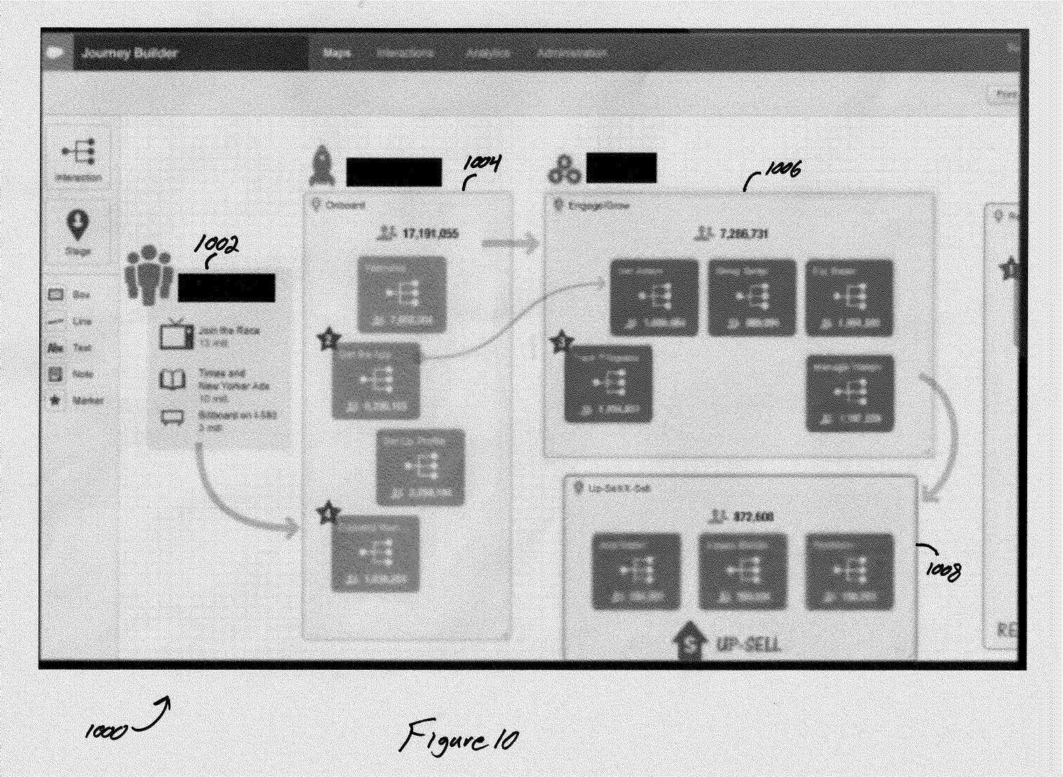

As a more specific example, FIG. 9 shows an example of an interface 900 provided by the experience-building application 502 for enabling a hotel organization to view, access or generate a customized experience for a customer according to some implementations. The experience illustrated in the example interface 900 of FIG. 9 includes a pre-arrival stage that includes one or more activities associated with a period prior to a customer's arriving at the hotel, an arrival stage that includes one or more activities associated with the customer's arrival at the hotel, a “stay” stage that includes one or more activities associated with the customer's stay at the hotel, a departure stage that includes one or more activities associated with the customer's departure from the hotel, an a post-stay stage that includes one or more activities associated with a period after the customer departs from the hotel.

As another example, an organization such as a ground transportation organization such as a bus, shuttle, train, taxi or other organization (for example, UBER) also can generate experiences for a customer or, additionally or alternatively, be requested by another (“master” or “managing”) organization to facilitate the other organization's experience provided to the customer.

In some implementations, various customized experiences also can be associated with other activities other than travel activities. For example, such organizations can include health-services providers (for example, a hospital, gym, doctor, dietician, health or physical therapist), activity-tracking or fitness-promoting organizations (for example, Fitbit Inc., Nike, or Jawbone). Such experiences can include customer activities such as medical appointments, therapy sessions, fitness or exercise activity sessions, meal-planning or meals, as well as activities associated with the sharing, analyzing, and planning of other activities based on information obtained from such activities.

As another example, other organizations such as security (for example, home security) organizations, utility companies or providers, home automation system providers (for example, Nest Labs), PC power management system (for example, the NightWatchman by 1E) providers, various green computing organizations, or other organizations can provide experiences associated with such systems via the experience-generating platform 500 enabling an amalgamated experience in and around a customer's home.

In some implementations, an organization can be an organization that can provide authentication, transaction or location services to a customer or to some or all of the organizations described above to facilitate another organization's experience or to facilitate an amalgamated experience. In some implementations, information associated with the authentication, transaction or location services is provided by an organization to the experience-generating platform 500, which then can distribute the information or information based on the received information to other ones of the organizations. In some implementations, the authentication, transaction or location services are provided by an organization directly to other ones of the organizations or to the customer without first providing the information to the experience-generating platform 500.

In some implementations, trigger data can include authentication data, transaction data or location data defining one or more triggers associated with each of the activities. The types of triggers or corresponding events desirably associated or included with various experiences can vary based on the needs of the customer or the organization or both. Some examples of some events that can be associated with an experience can include location-based events, for example, crossing a geofence, coming within a proximity of a location, entering a location (such as a building), passing a boundary, among others. Other events can include transaction-based events, for example, entering into or completing a business transaction, completing a banking or other payment transaction, or checking in to a location. Other events can include authentication-based events, for example, being authenticated, verified, or identified (for example, using an authentication device or application).

In some implementations, various activities and the triggers described above can be associated with or facilitated by a dedicated device or service, which may be a product of or be provided by a third-party organization. In some implementations, various activities and the triggers described above can be associated with or facilitated by an application on a customer's computing device (especially a customer's smartphone or other mobile computing device). In some implementations, an application executed by a mobile computing device can utilize information provided by another dedicated device.

For example, some activities can be facilitated by, and some triggers can be detected based on, various location services. Such locations services can be provided, for example, by a global positioning system (GPS) or other satellite navigation system (SNS)). Such SNS services can be provided by a dedicated GPS/SNS device or via an application on a customer's mobile device. In some implementations, such location services also can be provided via geofencing systems or techniques, Wi-Fi network location techniques (for example, via cellular triangulation techniques), or other wireless techniques using, for example, Bluetooth beacon transmitters or receivers, near field communications (NFC) transmitters or receivers, or other wireless location systems or techniques.

In some implementations, authentication services can be provided by a dedicated device or service or an application on a customer's computing device. For example, authentication services can be provided via a dedicated device such as the Nymi heart-rate-sensing wristband (by NYMI), a fingerprint scanner, a retina scanner or via an application on a mobile device such as a smartphone that can perform such functionality.

In some implementations, the activity data or trigger data defined for various organizations can include transaction data defining one or more transactions associated with each of the activities. In some implementations, a transaction itself can be an activity. Additionally or alternatively, an activity can include two or more transactions. In some implementations, a transaction can be a payment transaction, a business transaction, an authentication transaction, or another suitable or desired transaction.

In some implementations, the experience-building application 502 can generate or update an experience data object for each experience based on the experience data including the activity data as well as trigger data for the triggers defined or determined for the activities or experiences. In some such implementations, the experience-building application 502 stores, or causes to be stored, the experience data object in the database system 16.

In some implementations, the experience-building application 502 is further configured to amalgamate, combine, merge, link, chain, reconcile or otherwise integrate two or more experiences generated for the same customer to generate or determine an amalgamated experience for the customer. For example, the experience-building application 502 can advantageously generated an amalgamated experience that seamlessly links two or more experiences, facilitates handoffs between two or more experiences or two or more respective organizations, and which maintains a customer's identify and tracks the customer's actions (as event data) throughout a journey or flow through the experiences. In some implementations, the experience-building application 502 stores the amalgamated experience as an amalgamated experience data object in the database system 16. In some implementations, the amalgamated experience data object is a data object that includes the experience data objects for each of the experiences included in the amalgamated experience. In some other implementations, the experience-building application 502 stores a data structure or object that maps (or includes a mapping of) the included experiences, and more specifically, the triggers (and in some instances the activities) associated with the experiences included in the amalgamated experience.

As also described herein, various ones of the above organizations can form partnerships facilitating an amalgamated experience including experiences generated and provided by each of two or more of the above organizations. For example, an airline can partner with a car rental agency and a hotel to facilitate an amalgamated experience associated with a business trip or vacation. Such organizations can share information with one another. The experience-generating platform 500 can advantageously streamline the booking, planning, organizing, providing and handing off of various experiences, and the activities in the experiences, associated with such a trip from start to finish with minimal input from the customer and minimal interaction with representatives of the various organizations. For example, many of such activities can be automated and facilitated using a mobile device as described herein allowing a customer to bypass various lines and other experiences associated with physically interacting with human representatives or employees of the respective organizations during the trip.

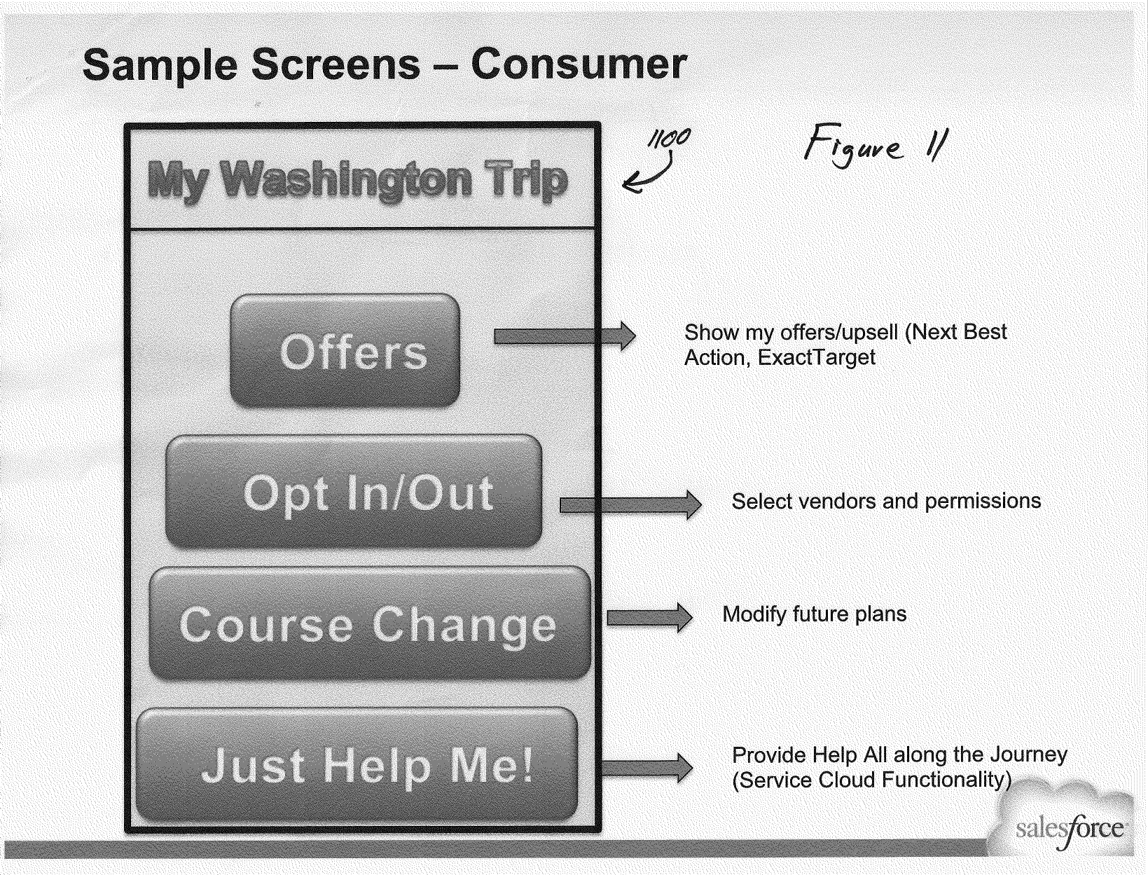

In some implementations, the experience-building application 502 generates the amalgamated experience such that the customer is not required to provide additional input or to access the experiences or respective organizations individually. That is, the customer can opt in to the organizations. FIG. 10 shows an example of an interface 1000 enabling an organization to generate an amalgamated experience for a customer by combining two or more customized experiences generated for the customer according to some implementations. The example interface 1000 includes a first experience 1002 (for example, an experience associated with an airline), a second experience 1004 (for example, an experience associated with rental car agency), a third experience 1006 (for example, an experience associated with a hotel), and a fourth experience 1008 (for example, an experience associated with a culmination point such as a conference, business meeting or interview). In some such implementations, the disparate organization that have generate respective experiences for a particular customer can form partnerships and share information (for example, by subscribing to information published by other ones of the organizations) to facilitate an overall more positive, seamless and simple journey through the various experiences as described in more detail above and below.

In some implementations, the experience-building application 502 is configured to map or otherwise analyze the experience data objects for the two or more experiences to be combined and to reconcile or otherwise advantageously associate various ones of the triggers defined for each of the experiences. In some implementations, the experience-building application 502 is configured to generate or determine one or more master triggers each indicating or defining a start or an end of a corresponding one of the individual experiences in the amalgamated experience. In some implementations, an originating (or “master,” “controlling” or “managing”) one of the organizations can define the master triggers. In some implementations, one or more of the master triggers include or are based on one or more of the triggers defined or determined for the individual experiences.

In some implementations, the experience-building applications 502 or the experience-mediating application 504 is capable or configured to provide an interface to a customer's computing device, for example, as a mobile application, a web UI or a web application. In some such implementations, the interface enables the customer to opt in to various organizations, or more specifically, to opt in to having experiences generated by various organizations. In some implementations, the interface also enables the customer to enter or upload identifying information, payment information, or other information that can be used by the experience-generating platform or ones of the organizations. In some implementations, the interface can enable the customer to view or modify the experiences included in an amalgamated experience generated for the customer by or using the experience-generating platform 500.

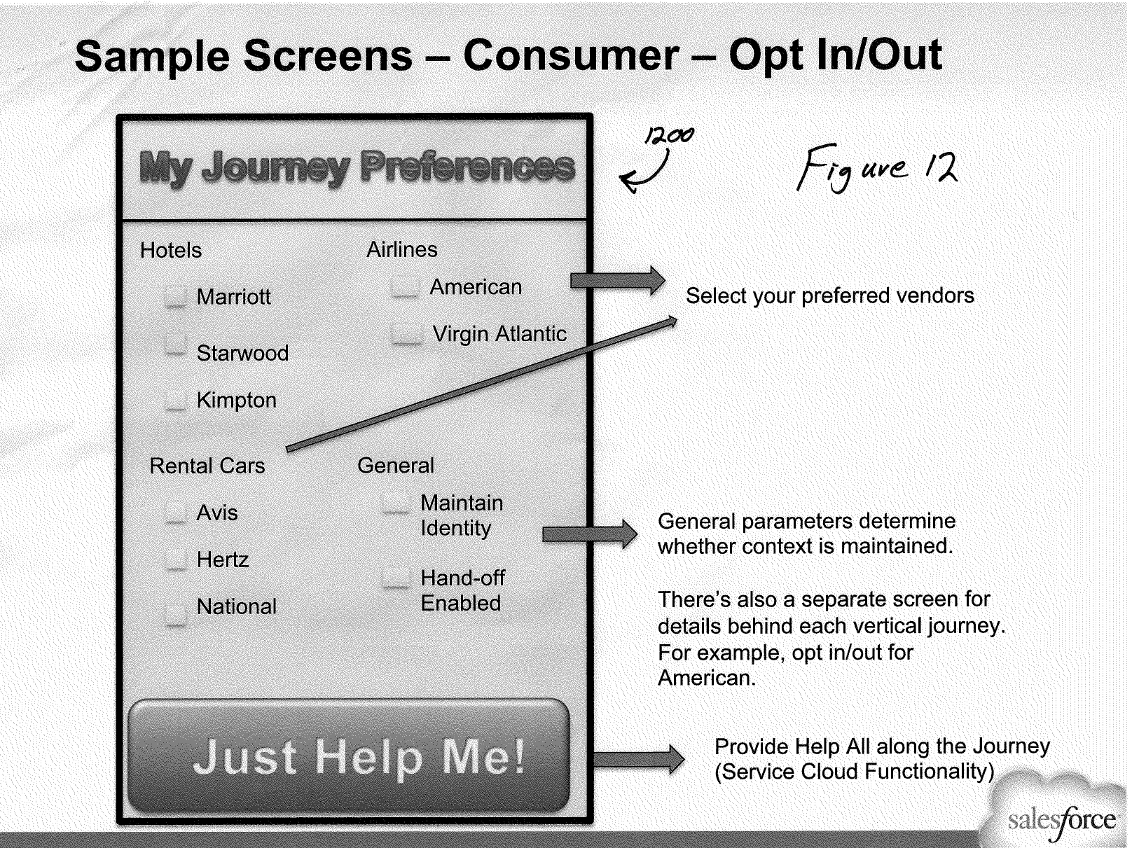

FIG. 11 shows an example of an interface enabling a customer to view or modify information associated with one or more customized experiences according to some implementations. For example, the interface of FIG. 11 can include a first button or UI element enabling the customer to show view offers of respective organizations, a second button or UI element enabling the customer to opt in or out of various organizations or associated experiences, a third button or UI element enabling the customer to modify one or more of the experiences and one or more of the associated activities, and a fourth button or UI element enabling the customer to obtain help about one or more of the experiences or the activities in such experiences. Regarding the latter, when the customer selects the help button, a request can be sent to the experience-generating platform 500 which then sends a corresponding request to the organization associated with the current experience the customer is engaged in. For example, the respective organization can then call the customer or communicate with the customer via one or more other channels whether directly or indirectly (for example, via the experience-generating platform 500).

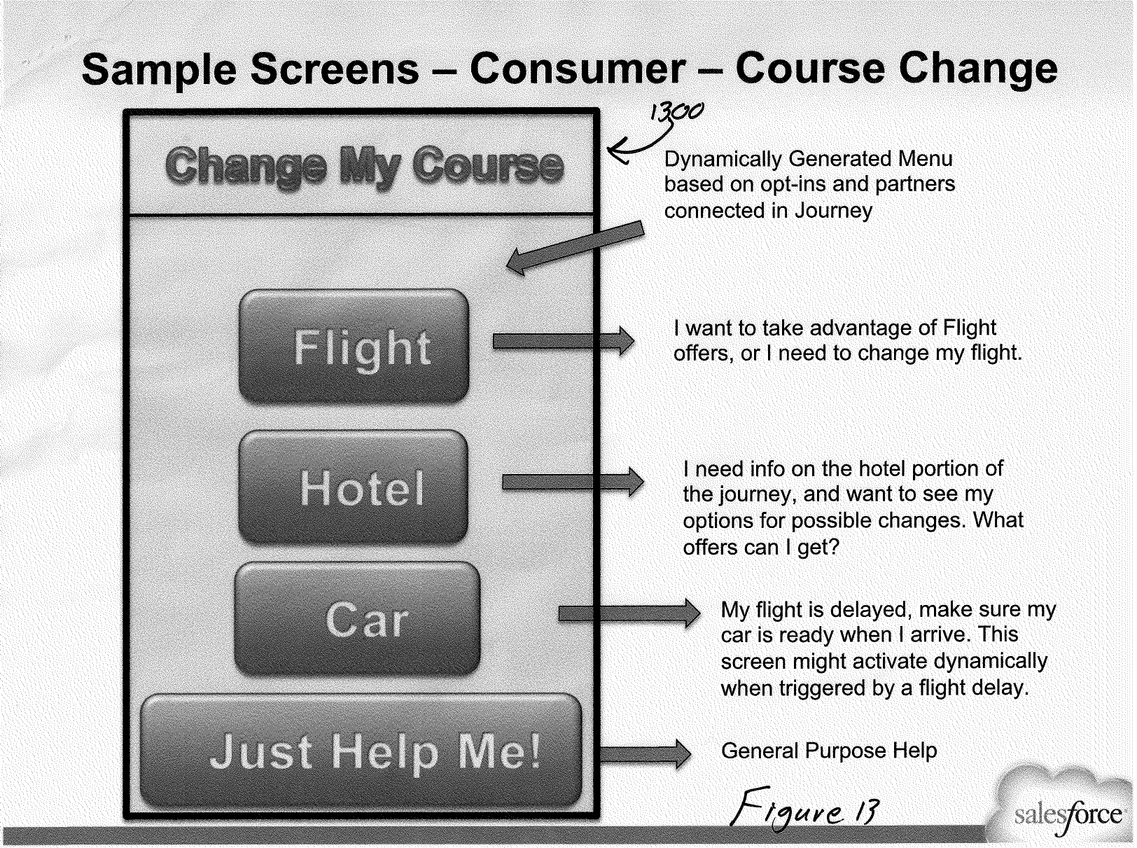

FIG. 12 shows an example of an interface enabling a customer to view or modify preferences associated with one or more customized experiences according to some implementations. For example, the interface of FIG. 12 enables the customer to opt in to a preferred organization for each of one or more different types of experiences (for example, an airline, a hotel or a car rental agency) as well as to opt in to various other general features, such as maintaining his or her identity across organizations or to enable handoffs between organization when transitioning from one organization to another.

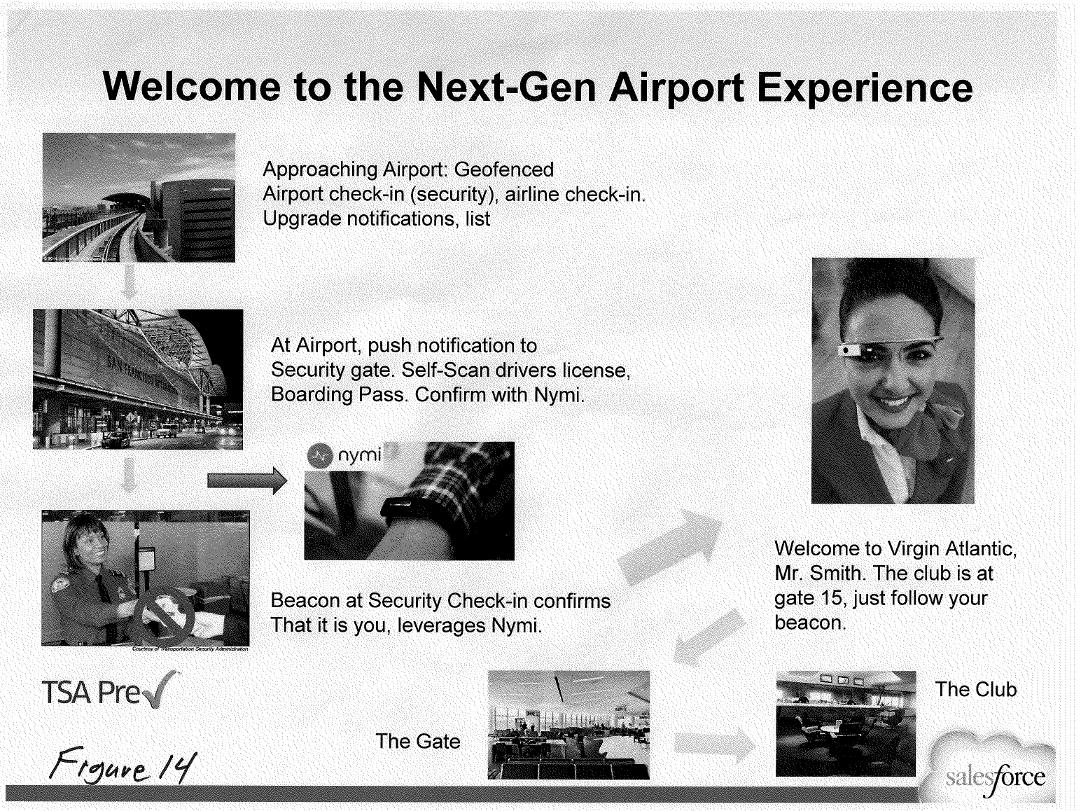

FIG. 13 shows an example of an interface enabling a customer to modify one or more activities associated with one or more customized experiences according to some implementations. For example, the interface can enable the customer to “change course” as in change an experience or an activity within an experience such as changing a flight reservation, changing a car rental reservation or changing a hotel reservation.

In some implementations, the experience-mediating application 504 is capable or configured to receive event data indicating the occurrence of an event, determine whether one or more triggers are satisfied based on the event data and, when a one of the triggers is satisfied, identify a next one of the activities. In some implementations, the experience-mediating application 504 is capable or configured to, responsive to identifying a next one of the activities, provide a corresponding notification to the user to facilitate the next one of the activities. In some implementations, the experience-mediating application 504 is capable or configured to, responsive to identifying a next one of the activities, provide a corresponding notification to the respective organization to facilitate the next one of the second activities.

In some implementations, the experience-mediating application 504 is capable or configured to, when a last one of the triggers is satisfied for a given one of the experiences in an amalgamated experience (or when a last one of the first activities is otherwise determined to completed in a given one of the experiences in an amalgamated experience), determine that the experience has ended and identify a first one of the activities in a next one of the experiences in the amalgamated experience.

In some implementations, the event data received by the experience-mediating application 504 is received from or published by the corresponding organization which generated the current experience for the customer. Additionally or alternatively, in some implementations, the event data received by the experience-mediating application 504 is received from or published by a third organization. For example, such a third organization can be an organization that provides authentication services, identification services, banking or other payment services, or other services that facilitate experiences generated by other ones of the organizations. Additionally or alternatively, in some implementations, the event data is received from a portable computing device of the user, for example, a mobile phone or tablet of the user. In some such implementations, the portable computing device can detect the event data. In some such implementations, the portable computing device can receive the event data from another computing device such as, for example, an authentication device or activity tracker (such as the Nymi band, FitBit band, or global positioning system (GPS) device or the like). In some implementations, the event data includes transaction data for a transaction associated with an activity. In some implementations, the event data includes location data associated with an activity. In some implementations, the event data includes authentication data associated with an activity. In some implementations, the event data includes data published by another one of the organizations.

In some implementations, the experience-mediating application 504 is further capable of or configured to provide some or all of the event data to other ones of the organizations that have generated custom experiences in the amalgamated experience for the customer. In some implementations, the experience-mediating application 504 is further capable of or configured to determine an identity of the customer based on the event data and to access the amalgamated experience data object or one or more of the associated individual custom experience data objects based on the identify.

In some implementations, the experience-mediating application 504 is further capable of or configured to determine whether to modify one or more of the experiences and the activities in such experiences based on the event data and to subsequently modify experiences when it is determined to do so. Additionally, in some implementations, as described with reference to FIG. 13, the experience-mediating application 504 or the experience-building application 502 can further be capable of or configured to provide an interface to the customer (for example, a menu) enabling the user to select to change an experience. In such implementations, the event data can include such a selection to modify from the customer to add a new activity, delete an existing activity, or modify an existing activity. In some other implementations, the experience-mediating application 504 can automatically determine to modify an experience or activity in an experience when the event data indicates that one or more activities need to be modified, for example, based on a delay in some portion of a segment of travel (for example, a flight delay). In some such implementations, the experience-mediating application 504 also can automatically determine to modify one or more of the triggers, including the master triggers, when the event data indicates that one or more activities need to be modified.

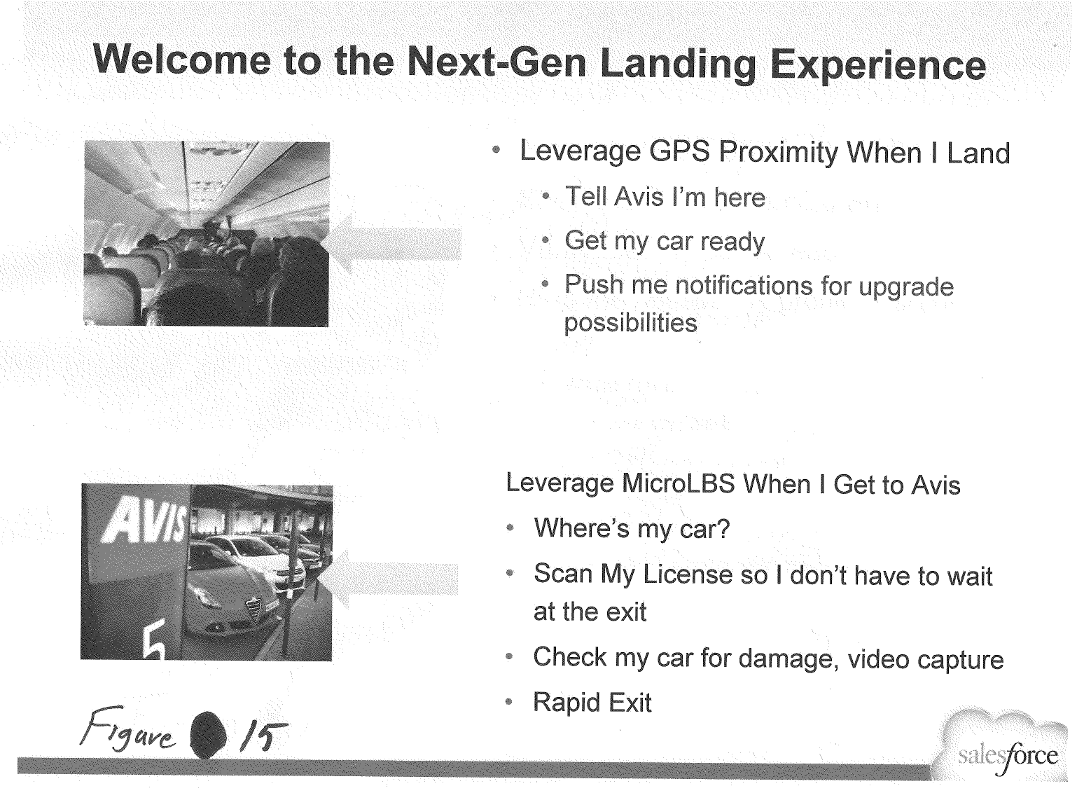

FIG. 14 shows a graphical representation of an example of a process flow for an airline flight experience according to some implementations and applications.

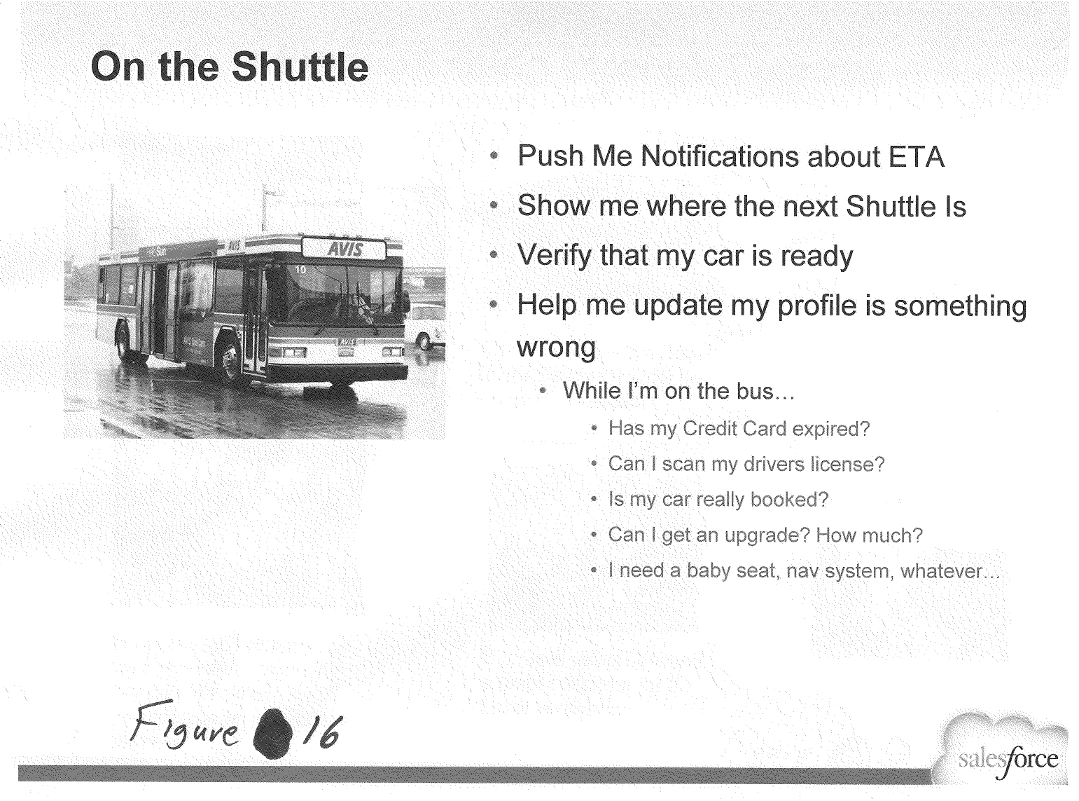

FIG. 15 shows a graphical representation of an example of a process flow for an airline landing experience according to some implementations and applications.

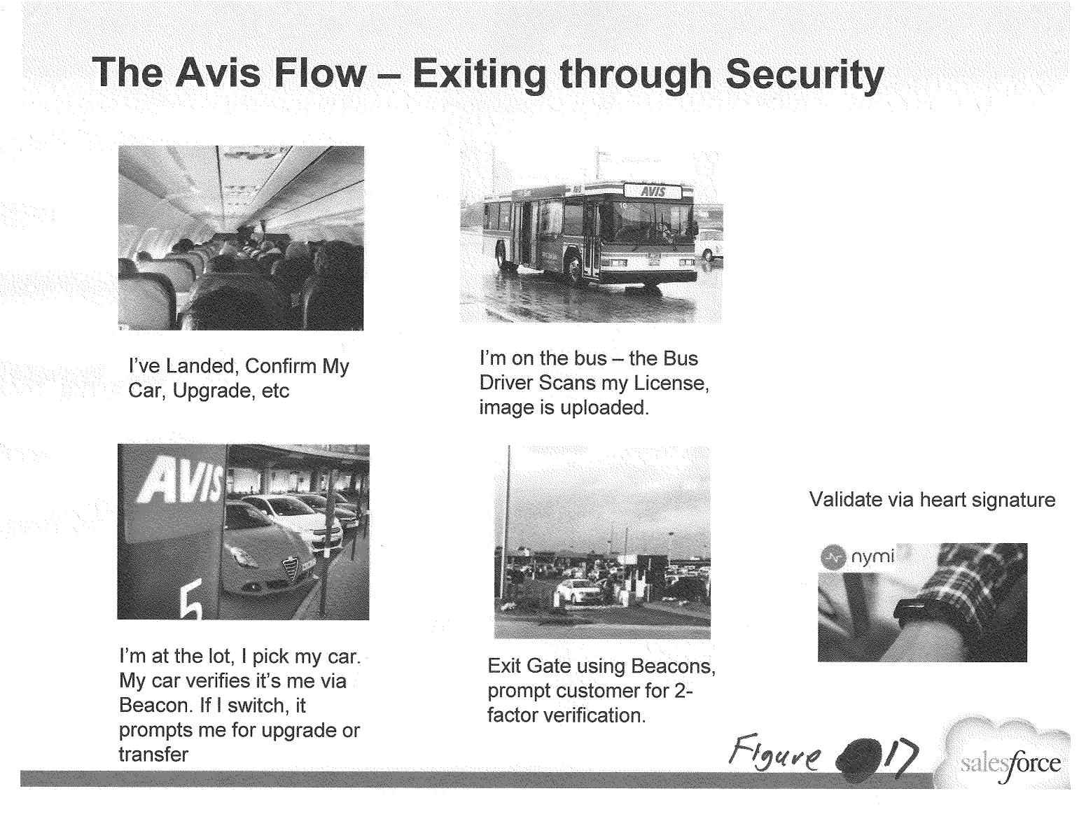

FIG. 16 shows a graphical representation of an example of a process flow for a shuttle experience according to some implementations and applications.

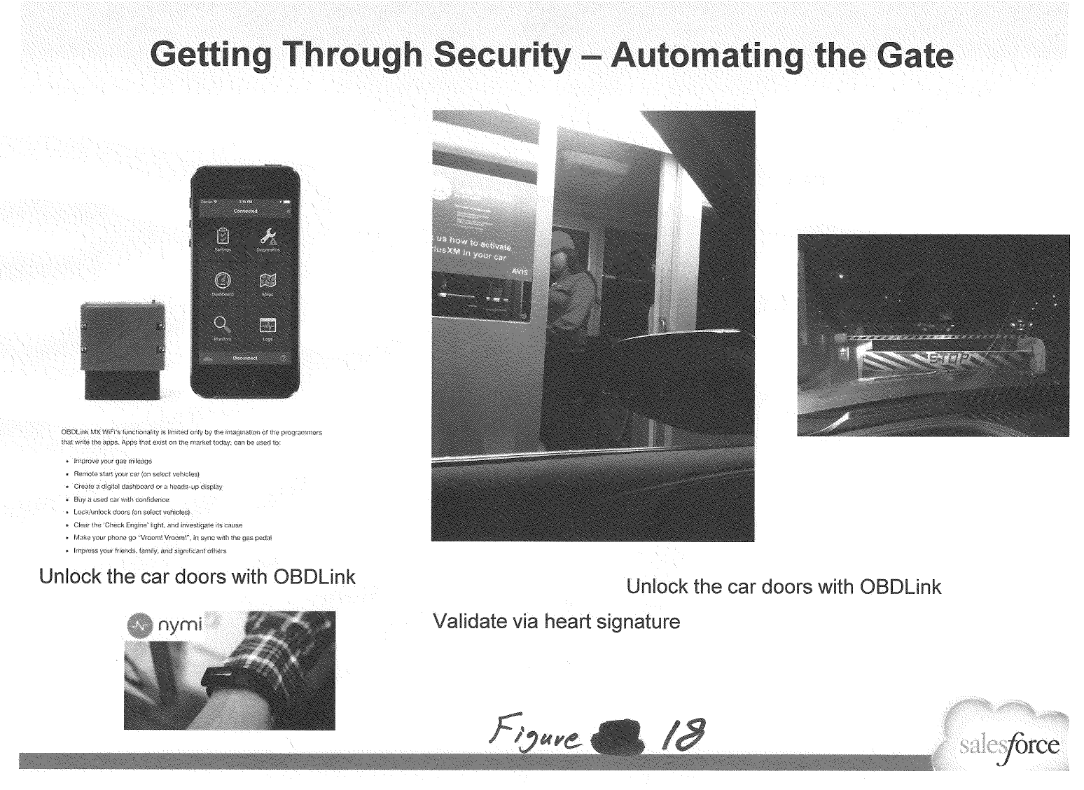

FIG. 17 shows a graphical representation of an example of a process flow for a car rental experience according to some implementations and applications.

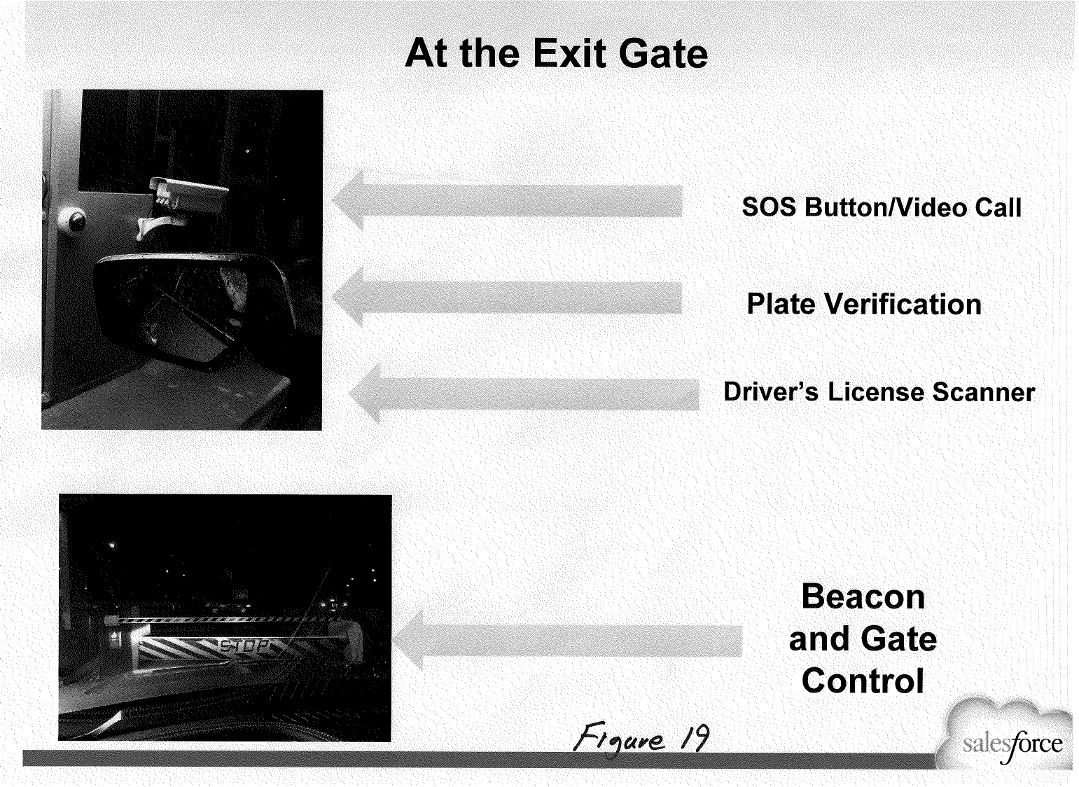

FIG. 18 shows a graphical representation of an example of a process flow for a gate automation activity associated with a car rental experience according to some implementations and applications.

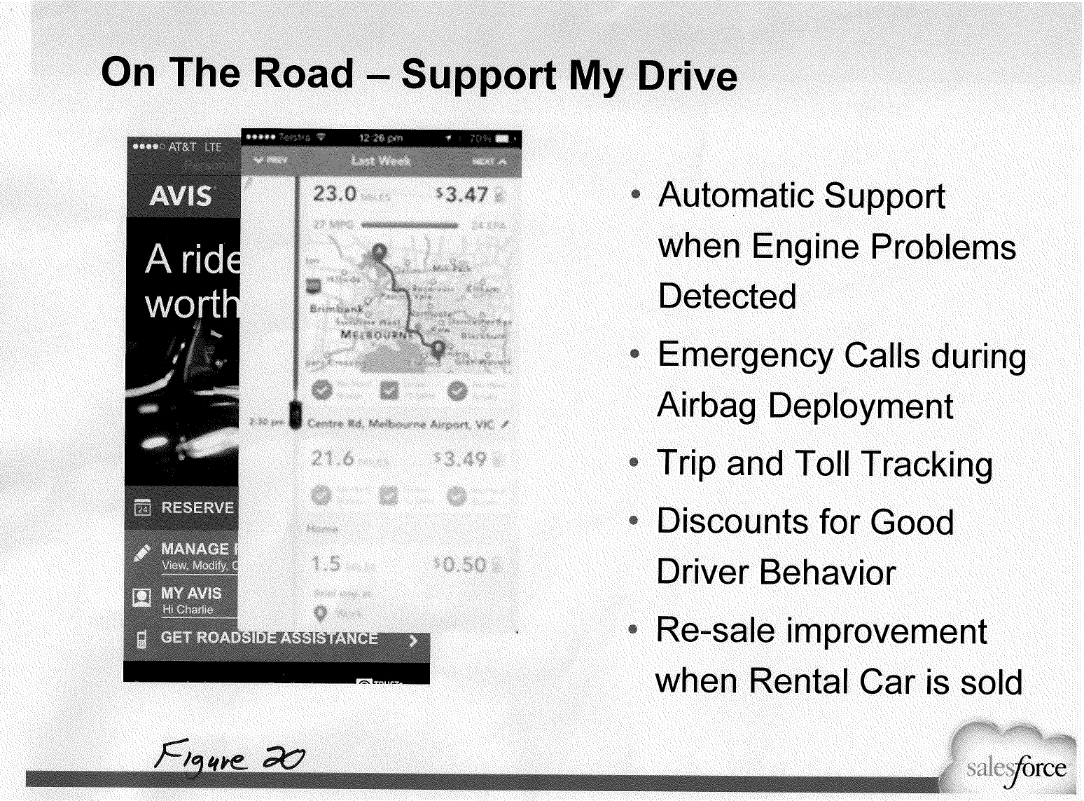

FIG. 19 shows a graphical representation of an example of a process flow for a gate automation activity associated with a car rental experience according to some implementations and applications. The experience/activity can also include using a beacon to determine the car's presence at the gate. The activity also can include generating an automatic damage image record (taking a picture of damage at the gate), using a picture to verify a license plate of the car, and scanning a driver's license: all to facilitate an automatic exit/gate control and damage record without requiring a car rental agency attendant.

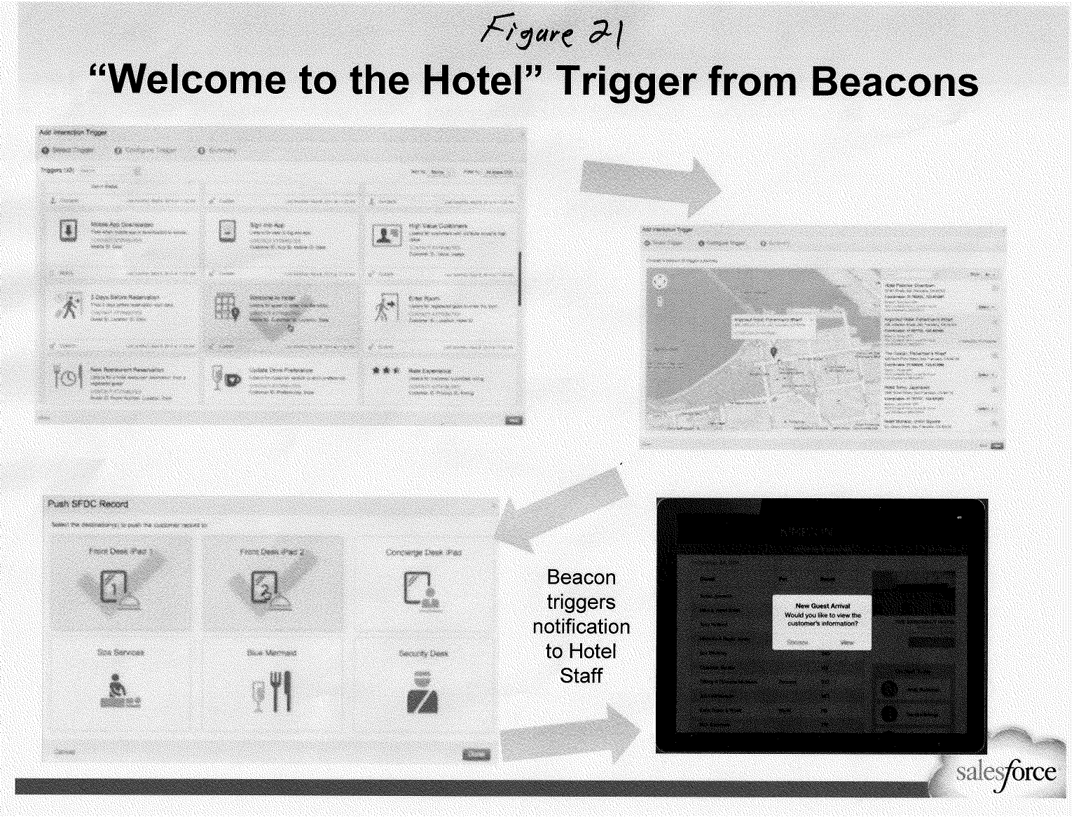

FIG. 20 shows a graphical representation of an example of a process flow for a car rental navigation and support experience according to some implementations and applications.

FIG. 21 shows a graphical representation of an example of a process flow for a hotel experience according to some implementations and applications.

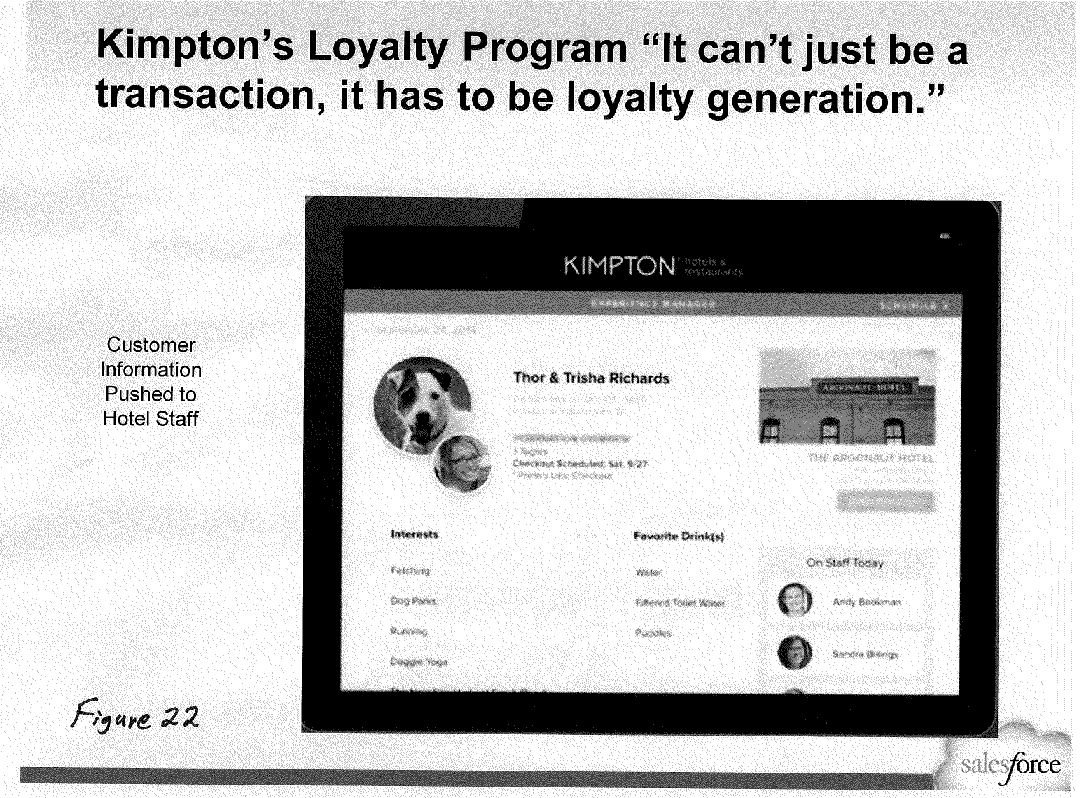

FIG. 22 shows a graphical representation of an example of an interface for use by a hotel in providing a customized experience to a customer of the hotel to some implementations and applications.

The following is an example of a use case that can be accomplished with the systems, devices, platforms, applications, and methods described herein:

1) Register my heartbeat signature via the Nymi band with TSA and for example, American Airlines.

2) When I arrive at the airport, it should authenticate my boarding pass and provide me with the ability to walk through the bluetooth-enabled scanner. The camera scans my drivers licenses and lets me pass through the TSA PRE scan. It will authenticate using my heartbeat signature encrypted key and my iPhone. (2-factor security). I am led to the gate via beacons and my iPhone.

3) I board the plane without human interaction as I walk through the gate onto the plane.

4) When I land Avis is notified via geofencing to prepare my car. When I get on the shuttle bus it enables my phone to open the door locks via the OBD-II device in the car. The iBeacon on my iPhone leads me to my rental car and my Nymi authenticates me to open the car door. The keys are already in the car.

5) As I drive through the gate my Nymi works with my iPhone to open the parking lot gate after my driver's license is successfully scanned by the gate camera. The gate camera also scans my car for damage and a “health” snapshot of the car. Avis is notified that their valuable asset, the vehicle, has left the lot.

6) As I approach the hotel my iPhone GPS notifies the hotel via geofencing that I am near and enables my Brivo Systems lock on the hotel door. As I enter the lobby I'm automatically checked in, authenticated by my Nymi and I walk to my room. The room number was sent to my iPhone. I am led to my room by iBeacons and my iPhone. My door opens as I approach it.

7) I have just experienced an end-to-end Customer Journey built via ET Customer Journey Builder combined with Visual Workflow and some customforce.com code. The device data is aggregated on Heroku and Project Matrix analyzes and reacts to the data streams. Salesforce Analytics listens, reacts and “proacts.”

The specific details of the specific aspects of implementations disclosed herein may be combined in any suitable manner without departing from the spirit and scope of the disclosed implementations. However, other implementations may be directed to specific implementations relating to each individual aspect, or specific combinations of these individual aspects. Additionally, while the disclosed examples are often described herein with reference to an implementation in which an on-demand database service environment is implemented in a system having an application server providing a front end for an on-demand database service capable of supporting multiple tenants, the present implementations are not limited to multi-tenant databases or deployment on application servers. Implementations may be practiced using other database architectures, i.e., ORACLE®, DB2® by IBM and the like without departing from the scope of the implementations claimed.

It should also be understood that some of the disclosed implementations can be embodied in the form of various types of hardware, software, firmware, or combinations thereof, including in the form of control logic, and using such hardware or software in a modular or integrated manner. Other ways or methods are possible using hardware and a combination of hardware and software. Additionally, any of the software components or functions described in this application can be implemented as software code to be executed by one or more processors using any suitable computer language such as, for example, Java, C++ or Perl using, for example, existing or object-oriented techniques. The software code can be stored as a computer- or processor-executable instructions or commands on a physical non-transitory computer-readable medium. Examples of suitable media include random access memory (RAM), read only memory (ROM), magnetic media such as a hard-drive or a floppy disk, or an optical medium such as a compact disk (CD) or DVD (digital versatile disk), flash memory, and the like, or any combination of such storage or transmission devices. Computer-readable media encoded with the software/program code may be packaged with a compatible device or provided separately from other devices (for example, via Internet download). Any such computer-readable medium may reside on or within a single computing device or an entire computer system, and may be among other computer-readable media within a system or network. A computer system, or other computing device, may include a monitor, printer, or other suitable display for providing any of the results mentioned herein to a user.

While some implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

Various implementations relate to the following combinations of systems, devices, components, elements, methods, blocks, steps or features:

combination 1.

A system comprising:

a database system storing:
a first experience data object associated with a first organization and including first experience data defining a first experience for the user, the first experience data including:
   activity data for one or more first activities associated with the first experience, and
   trigger data defining one or more first triggers each defining a start or an end of a corresponding one of the first activities;
a second experience data object associated with a second organization and including second experience data defining a second experience for the user, the second experience data including:
   activity data for one or more second activities associated with the second experience, and
   trigger data defining one or more second triggers each defining
a start or an end of a corresponding one of the second activities; and one or more processors operable to:
receive event data indicating the occurrence of an event;
determine whether one or more of the first or the second triggers are satisfied based on the event data;
when a one of the first triggers is satisfied, identify a next one of the first activities;
when a one of the second triggers is satisfied, identify a next one of the second activities; and
when a last one of the first triggers is satisfied or a last one of the first activities is determined to completed, determine that the first experience has ended and identify a first one of the second activities.

combination 2.

The system of combination 1, the one or more processors being further operable to, responsive to identifying a next one of the first or the second activities, provide a corresponding notification to the user to facilitate the next one of the first or the second activities.

combination 3.

The system of combination 1, the one or more processors being further operable to, responsive to identifying a next one of the first or the second activities, provide a corresponding notification to the respective first or the second organization to facilitate the next one of the first or the second activities.

combination 4.

The system of combination 1, the one or more processors being further operable to receive option data indicating that the user has selected to opt in to having the first and the second experiences generated for the user by the respective first and second organizations.

combination 5.

The system of combination 1, the event data being received from the first or the second organization.

combination 6.

The system of combination 1, the event data being received from a third organization.

combination 7.

The system of combination 1, the event data being received from a portable computing device of the user.

combination 8.

The system of combination 1, the event data including transaction data for a transaction associated with a one of the first or the second activities.

combination 9.

The system of combination 7, the one or more processors being further operable to provide the transaction data to the first or the second organization.

combination 10.

The system of combination 1, the event data including location data associated with a one of the first or the second activities.

combination 11.

The system of combination 10, the one or more processors being further operable to provide the location data to the first or the second organization.

combination 12.

The system of combination 1, the event data including authentication data associated with a one of the first or the second activities.

combination 13.

The system of combination 12, the database system further storing a user data object including identification data identifying a the user, the one or more processors being further operable to authenticate the user based on the authentication data and the identification data.

combination 14.

The system of combination 12, the one or more processors being further operable to provide an indication to the first or the second organization that the user is authenticated.

combination 15.

The system of combination 1, the event data including data published by the first or the second organization.

combination 16.

The system of combination 15, the one or more processors being further operable to provide the published data to the other one of the first or the second organizations.

combination 17.

The system of combination 1, the one or more processors being further operable to determine an identity of the first user based on the event data and to access the first or the second experience data object based on the identify.

combination 18.

The system of combination 1, the one or more processors being further operable to:

determine whether to modify one or more of the first or the second activities based on the event data; and

modify one or more of the first or the second activities based on the event data.

combination 19.

The system of combination 1, the one or more processors being further operable to:

determine whether to modify one or more of the first or the second triggers based on the event data; and

modify one or more of the first or the second triggers based on the event data.

combination 20.

A system comprising:

a database system; and

one or more processors operable to:
receive first experience data from a first organization defining a first experience for a user, the first experience data including activity data for one or more first activities associated with the first experience;
determine one or more first triggers each defining a start or an end of a corresponding one of the first activities;
generate or update a first experience data object to include the first experience data and the one or more first triggers;
store the first experience data object in the database system;
receive second experience data from a second organization defining a second experience for the user, the second experience data including activity data for one or more second activities associated with the second experience;
determine one or more second triggers each defining a start or an end of a corresponding one of the second activities;
generate or update a second experience data object to include the second experience data and the one or more second triggers;
store the second experience data object in the database system;
map the first experience data object and the second experience data object to reconcile the first and the second triggers;
determine one or more third triggers each defining a start or an end of a corresponding one of the first or the second experiences.

combination 21.

The system of combination 20, the one or more third triggers including one or more of the first triggers or one or more of the second triggers.

combination 22.

The system of combination 20, the one or more processors being further operable to provide an interface to the user enabling the user to opt in to having the first and the second experiences generated for the user by the respective first and second organizations.

combination 23.

The system of combination 20, the one or more processors being further operable to:

receive a request from each of the first and the second organizations to register with the database system;

register the first and the second organizations with the database system based on the respective requests;

generate a first and a second organization data object for the respective first and second organizations; and

store the first and the second organization data objects in the database system.

combination 24.

The system of combination 20, the one or more processors being further operable to provide an interface to each of the first and the second organizations, the interface enabling the respective organization to:

enter or access information about the user; and

customize the first and the second experiences for the user based on the information about the user.

combination 25.

The system of combination 24, the interface further enabling the respective one of the first and the second organizations to define or select the one or more activities for the respective one of the first and the second experiences.

combination 26.

The system of combination 25, the interface further enabling the respective one of the first and the second organizations to define or select one or more transactions associated with respective ones of the one or more activities.

combination 27.

The system of combination 24, the interface further enabling the respective one of the first and the second organizations to define or select the one or more triggers for the respective one of the first and the second experiences.

combination 28.

The system of combination 27, the interface further enabling the respective one of the first and the second organizations to define or select one or more events associated with respective ones of the one or more triggers.

combination 29.

The system of combination 20, the one or more processors being further operable to:

receive a request from the first organization to subscribe to data published by the second organization; and

subscribe the first organization to the data published by the second organization.

combination 30.

The system of combination 29, the one or more processors being further operable to:

receive data published by the second organization; and

automatically provide the published data to the first organization.

combination 31.

A computer-implemented method comprising:

receiving first experience data defining a first experience for a user, the first experience data including:
activity data for one or more first activities associated with the first experience, and
trigger data defining one or more first triggers each defining a start or an end of a corresponding one of the first activities;

receiving second experience data defining a second experience for the user, the second experience data including:
activity data for one or more second activities associated with the second experience, and
trigger data defining one or more second triggers each defining a start or an end of a corresponding one of the second activities;

receiving event data indicating the occurrence of an event;

determining whether one or more of the first or the second triggers are satisfied based on the event data; and
when a one of the first triggers is satisfied, identify a next one of the first activities;
when a one of the second triggers is satisfied, identify a next one of the second activities; and
when a last one of the first triggers is satisfied or a last one of the first activities is determined to completed, determine that the first experience has ended and identify a first one of the second activities.

combination 32.

The method of combination 31, further including, responsive to identifying a next one of the first or the second activities, providing a corresponding notification to the user to facilitate the next one of the first or the second activities.

combination 33.

The method of combination 31, further including, responsive to identifying a next one of the first or the second activities, providing a corresponding notification to the respective first or the second organization to facilitate the next one of the first or the second activities.

combination 34.

The method of combination 31, further including receiving option data indicating that the user has selected to opt in to having the first and the second experiences generated for the user by the respective first and second organizations.

combination 35.

The method of combination 31, the event data being received from the first or the second organization.

combination 36.

The method of combination 31, the event data being received from a third organization.

combination 37.

The method of combination 31, the event data being received from a portable computing device of the user.

combination 38.

The method of combination 31, the event data including transaction data for a transaction associated with a one of the first or the second activities.

combination 39.

The method of combination 37, further including providing the transaction data to the first or the second organization.

combination 40.

The method of combination 31, the event data including location data associated with a one of the first or the second activities.

combination 41.

The method of combination 40, further including providing the location data to the first or the second organization.

combination 42.

The method of combination 31, the event data including authentication data associated with a one of the first or the second activities.

combination 43.

The method of combination 42, further including storing a user data object including identification data identifying a the user, the method further including authenticating the user based on the authentication data and the identification data.

combination 44.

The method of combination 42, further including providing an indication to the first or the second organization that the user is authenticated.

combination 45.

The method of combination 31, the event data including data published by the first or the second organization.

combination 46.

The method of combination 45, further including providing the published data to the other one of the first or the second organizations.

combination 47.

The method of combination 31, further including determining an identity of the first user based on the event data and to access the first or the second experience data object based on the identify.

combination 48.

The method of combination 31, further including:

determining whether to modify one or more of the first or the second activities based on the event data; and

modifying one or more of the first or the second activities based on the event data.

combination 49.

The method of combination 31, further including:

determining whether to modify one or more of the first or the second triggers based on the event data; and

modifying one or more of the first or the second triggers based on the event data.

combination 50.

A computer-implemented method comprising:

receiving first experience data from a first organization defining a first experience for a user, the first experience data including activity data for one or more first activities associated with the first experience;

determining one or more first triggers each defining a start or an end of a corresponding one of the first activities;

generating or updating a first experience data object to include the first experience data and the one or more first triggers;

storing the first experience data object in the database system;

receiving second experience data from a second organization defining a second experience for the user, the second experience data including activity data for one or more second activities associated with the second experience;

determining one or more second triggers each defining a start or an end of a corresponding one of the second activities;

generating or updating a second experience data object to include the second experience data and the one or more second triggers;

storing the second experience data object in the database system;

mapping the first experience data object and the second experience data object to reconcile the first and the second triggers; and

determining one or more third triggers each defining a start or an end of a corresponding one of the first or the second experiences.

combination 51.

The method of combination 50, the one or more third triggers including one or more of the first triggers or one or more of the second triggers.

combination 52.

The method of combination 50, further including providing an interface to the user enabling the user to opt in to having the first and the second experiences generated for the user by the respective first and second organizations.

combination 53.

The method of combination 50, further including:

receiving a request from each of the first and the second organizations to register with the database system;

registering the first and the second organizations with the database system based on the respective requests;

generating a first and a second organization data object for the respective first and second organizations; and

storing the first and the second organization data objects in a database system.

combination 54.

The method of combination 50, further including providing an interface to each of the first and the second organizations, the interface enabling the respective organization to:

enter or access information about the user; and

customize the first and the second experiences for the user based on the information about the user.

combination 55.

The method of combination 54, the interface further enabling the respective one of the first and the second organizations to define or select the one or more activities for the respective one of the first and the second experiences.

combination 56.

The method of combination 55, the interface further enabling the respective one of the first and the second organizations to define or select one or more transactions associated with respective ones of the one or more activities.

combination 57.

The method of combination 54, the interface further enabling the respective one of the first and the second organizations to define or select the one or more triggers for the respective one of the first and the second experiences.

combination 58.

The method of combination 57, the interface further enabling the respective one of the first and the second organizations to define or select one or more events associated with respective ones of the one or more triggers.

combination 59.

The method of combination 50, further including:

receiving a request from the first organization to subscribe to data published by the second organization; and

subscribing the first organization to the data published by the second organization.

combination 60.

The method of combination 59, further including:

receiving data published by the second organization; and

automatically providing the published data to the first organization.

What is claimed is:

1. A system comprising:
a database system storing:
a first experience data object associated with a first organization and including first experience data defining a first experience for the user, the first experience data including:
activity data for one or more first activities associated with the first experience, and
trigger data defining one or more first triggers each defining a start or an end of a corresponding one of the first activities;
a second experience data object associated with a second organization and including second experience data defining a second experience for the user, the second experience data including:
activity data for one or more second activities associated with the second experience, and
trigger data defining one or more second triggers each defining
a start or an end of a corresponding one of the second activities; and
one or more processors operable to:
receive event data indicating the occurrence of an event;
determine whether one or more of the first or the second triggers are satisfied based on the event data;
when a one of the first triggers is satisfied, identify a next one of the first activities;
when a one of the second triggers is satisfied, identify a next one of the second activities; and
when a last one of the first triggers is satisfied or a last one of the first activities is determined to completed, determine that the first experience has ended and identify a first one of the second activities.

2. The system of claim 1, the one or more processors being further operable to, responsive to identifying a next one of the first or the second activities, provide a corresponding notification to the user to facilitate the next one of the first or the second activities.

3. The system of claim 1, the one or more processors being further operable to, responsive to identifying a next one of the first or the second activities, provide a corresponding notification to the respective first or the second organization to facilitate the next one of the first or the second activities.

4. The system of claim 1, the one or more processors being further operable to receive option data indicating that the user has selected to opt in to having the first and the second experiences generated for the user by the respective first and second organizations.

5. The system of claim 1, the event data including location data associated with a one of the first or the second activities.

6. The system of claim 1, the event data including authentication data associated with a one of the first or the second activities.

7. The system of claim 1, the one or more processors being further operable to determine an identity of the first user based on the event data and to access the first or the second experience data object based on the identify.

8. The system of claim 1, the one or more processors being further operable to:
determine whether to modify one or more of the first or the second activities based on the event data; and
modify one or more of the first or the second activities based on the event data.

9. A system comprising:
a database system; and
one or more processors operable to:
receive first experience data from a first organization defining a first experience for a user, the first experience data including activity data for one or more first activities associated with the first experience;
determine one or more first triggers each defining a start or an end of a corresponding one of the first activities;
generate or update a first experience data object to include the first experience data and the one or more first triggers;
store the first experience data object in the database system;
receive second experience data from a second organization defining a second experience for the user, the second experience data including activity data for one or more second activities associated with the second experience;
determine one or more second triggers each defining a start or an end of a corresponding one of the second activities;
generate or update a second experience data object to include the second experience data and the one or more second triggers;
store the second experience data object in the database system;
map the first experience data object and the second experience data object to reconcile the first and the second triggers;
determine one or more third triggers each defining a start or an end of a corresponding one of the first or the second experiences.

10. The system of claim 9, the one or more third triggers including one or more of the first triggers or one or more of the second triggers.

11. The system of claim 9, the one or more processors being further operable to provide an interface to the user enabling the user to opt in to having the first and the second experiences generated for the user by the respective first and second organizations.

12. The system of claim 9, the one or more processors being further operable to provide an interface to each of the first and the second organizations, the interface enabling the respective organization to:
enter or access information about the user; and
customize the first and the second experiences for the user based on the information about the user.

13. The system of claim 12, the interface further enabling the respective one of the first and the second organizations to define or select the one or more activities for the respective one of the first and the second experiences.

14. The system of claim 12, the interface further enabling the respective one of the first and the second organizations to define or select the one or more triggers for the respective one of the first and the second experiences.

15. The system of claim 9, the one or more processors being further operable to:
receive a request from the first organization to subscribe to data published by the second organization; and
subscribe the first organization to the data published by the second organization.

16. A computer-implemented method comprising:
receiving first experience data defining a first experience for a user, the first experience data including:
activity data for one or more first activities associated with the first experience, and
trigger data defining one or more first triggers each defining a start or an end of a corresponding one of the first activities;
receiving second experience data defining a second experience for the user, the second experience data including:
activity data for one or more second activities associated with the second experience, and
trigger data defining one or more second triggers each defining a start or an end of a corresponding one of the second activities;
receiving event data indicating the occurrence of an event;
determining whether one or more of the first or the second triggers are satisfied based on the event data; and
when a one of the first triggers is satisfied, identify a next one of the first activities;
when a one of the second triggers is satisfied, identify a next one of the second activities; and
when a last one of the first triggers is satisfied or a last one of the first activities is determined to completed, determine that the first experience has ended and identify a first one of the second activities.

17. The method of claim 16, further including, responsive to identifying a next one of the first or the second activities, providing a corresponding notification to the user to facilitate the next one of the first or the second activities.

18. The method of claim 16, further including, responsive to identifying a next one of the first or the second activities, providing a corresponding notification to the respective first or the second organization to facilitate the next one of the first or the second activities.

19. The method of claim 16, further including receiving option data indicating that the user has selected to opt in to having the first and the second experiences generated for the user by the respective first and second organizations.

20. The method of claim 16, the event data including location data associated with a one of the first or the second activities.

21. The method of claim 16, the event data including authentication data associated with a one of the first or the second activities.

22. The method of claim 16, further including:
determining whether to modify one or more of the first or the second activities based on the event data; and
modifying one or more of the first or the second activities based on the event data.

23. A computer-implemented method comprising:
receiving first experience data from a first organization defining a first experience for a user, the first experience data including activity data for one or more first activities associated with the first experience;
determining one or more first triggers each defining a start or an end of a corresponding one of the first activities;
generating or updating a first experience data object to include the first experience data and the one or more first triggers;
storing the first experience data object in the database system;
receiving second experience data from a second organization defining a second experience for the user, the second experience data including activity data for one or more second activities associated with the second experience;
determining one or more second triggers each defining a start or an end of a corresponding one of the second activities;
generating or updating a second experience data object to include the second experience data and the one or more second triggers;
storing the second experience data object in the database system;
mapping the first experience data object and the second experience data object to reconcile the first and the second triggers; and
determining one or more third triggers each defining a start or an end of a corresponding one of the first or the second experiences.

24. The method of claim 23, the one or more third triggers including one or more of the first triggers or one or more of the second triggers.

25. The method of claim 23, further including providing an interface to the user enabling the user to opt in to having the first and the second experiences generated for the user by the respective first and second organizations.

26. The method of claim 23, further including providing an interface to each of the first and the second organizations, the interface enabling the respective organization to:
enter or access information about the user; and
customize the first and the second experiences for the user based on the information about the user.

27. The method of claim 26, the interface further enabling the respective one of the first and the second organizations to define or select the one or more activities for the respective one of the first and the second experiences.

28. The method of claim 26, the interface further enabling the respective one of the first and the second organizations to define or select the one or more triggers for the respective one of the first and the second experiences.

29. The method of claim 28, the interface further enabling the respective one of the first and the second organizations to define or select one or more events associated with respective ones of the one or more triggers.

30. The method of claim 16, further including:
receiving a request from the first organization to subscribe to data published by the second organization; and
subscribing the first organization to the data published by the second organization.
